(19) United States
(12) Patent Application Publication
(10) Pub. No.: US 2025/0320168 A1
(43) Pub. Date: Oct. 16, 2025

(54) WATER RESISTANT GYPSUM FIBERBOARD AND PROCESS FOR MAKING SAME

(71) Applicant: UNITED STATES GYPSUM COMPANY, Chicago, IL (US)

(72) Inventors: Ashish Dubey, Grayslake, IL (US); Michael Patrick Shake, Johnsburg, IL (US); Christopher Bond Tesmer, McHenry, IL (US)

(73) Assignee: UNITED STATES GYPSUM COMPANY, Chicago, IL (US)

(21) Appl. No.: 19/018,451

(22) Filed: Jan. 13, 2025

Related U.S. Application Data
(60) Provisional application No. 63/632,808, filed on Apr. 11, 2024.

(51) Int. Cl. C04B 41/63; C04B 18/24; C04B 24/42; C04B 28/14; C04B 41/45; C04B 41/48; C04B 103/65; C04B 111/00; C04B 111/27; C09D 5/02; C09D 5/16; C09D 7/40; C09D 7/61; C09D 7/63; C09D 125/14

(52) U.S. Cl. CPC C04B 41/63; C04B 18/24; C04B 24/42; C04B 28/14; C04B 41/4539; C04B 41/483; C09D 5/022; C09D 5/1668; C09D 7/61; C09D 7/63; C09D 7/69; C09D 125/14; C04B 2103/65; C04B 2111/00629; C04B 2111/27

(57) ABSTRACT

A gypsum fiber panel (GFP) including a fiber-reinforced gypsum board core layer including gypsum, cellulose fibers embedded uniformly throughout the core layer, a siloxane level of 0 to about 1.0 wt. %, uniformly distributed within the gypsum board core layer; and a hydrophobic coating on the core layer. The hydrophobic coating includes a film forming polymer, and at least one of: a non-setting inorganic filler, having a volume mean particle diameter of about 4 microns to about 100 microns, and a hydraulic component comprising a fly ash. If the hydraulic component is present, the hydrophobic coating further includes at least one of an extended flow time retention agent. The gypsum fiber panel has no facer mat or mesh on its surface and no embedded mat or mesh.

### FIELD OF THE INVENTION

This invention relates generally to an improved gypsum cellulose fiber composite panels suitable for building applications for wallboard, ceiling boards, tile backer boards, roof boards, framing and sheathing elements, siding elements, and other building construction types. More generically these inventive boards are fiber reinforced gypsum fiberboard panels (hereinafter also referred to as “gypsum fiber panels”, “gypsum fiber board panels” or “GFP”). The GFP has a core layer of gypsum and paper fiber uniformly distributed throughout with other smaller dosed performance additives, such as siloxane for water resistance performance. The siloxane is also uniformly distributed in the core layer. It has no facer mat and has no embedded mat.

For purposes of this application the term “uniformly distributed” in the context of an ingredient in a core layer means the concentration (weight %) of the ingredient in a top zone defined as the top 10% of the thickness of the core and a bottom zone defined as the bottom 10% of the thickness of the core layer are each within 30% of the concentration of the ingredient in a middle zone of the core layer defined as the remaining 80% of the thickness of the core layer between the top and bottom zones. For example, if the middle zone has an ingredient concentration of 10 wt. % then the top and bottom zones have an ingredient concentration within a range from 10±3 wt. %.

### BACKGROUND OF THE INVENTION

Gypsum fiberboard panels (hereinafter also referred to as “gypsum fiber panels”, “gypsum fiber board panels” or “GFP”) have been used in the construction industry to form the interior and exterior walls of residential and/or commercial structures.

The flexural strength of a 0.5 inch (12.7 mm) thick gypsum fiberboard panels (GFP) having a density of about 897 kg/m³ (56 lb/ft³) to about 1000 kg/m³ (70 lb/ft³) is at least 5.2 MPa (750 psi), and preferably greater than 6.9 MPa (1000 psi) as measured by the ASTM D1037 test.

The gypsum fiber board panel should be dimensionally stable when exposed to water, i.e., it should expand as little as possible, preferably less than 0.1% as measured by ASTM C 1278. The Standard specification for some gypsum fiberboard panels is listed at 5% moisture uptake in a 2 hour soak, although other gypsum fiber board panel products can have as much as 10% moisture uptake in a 2 hour soak test. The panel should not be biodegradable or subject to attack by insects or rot. However, the panel should provide a bondable substrate for exterior finish systems.

There is a need for improved gypsum fiber based panels that are lightweight having improved water resistance while maintaining flexural toughness.

EP 3129333 B1 to Blackburn et al. discloses a gypsum fiber product comprising a core and a coating. The core comprises gypsum and siloxane and the coating comprises alkali metal organosiliconate. The core is coated on at least one side with the coating. At least a portion of siloxane is crosslinked at the surface of the gypsum fiber product. The siloxane is present in amounts of 0.08% to 1.0% by weight of the total amount of gypsum.

U.S. Pat. No. 10,232,588 to Xu et al. discloses preparing a gypsum slurry comprising a high-viscosity siloxane by mixing at least stucco, water, the high-viscosity siloxane, and at least one accelerator of siloxane polymerization; forming the gypsum slurry into a gypsum core of a gypsum product. Placing the slurry between cover sheets; allowing the gypsum slurry to set; and drying the gypsum product in a kiln. The method further comprises coating a water-resistant coating, such as potassium methyl siliconate, on at least one surface of the gypsum core.

EP 2117828 to Engbrecht et al., corresponding to U.S. Pat. No. 8,070,895 to Engbrecht et al., discloses a fibrous mat-faced cementitious article comprising (a) a cementitious core, and (b) a first fibrous mat comprising polymer or mineral fibers and a hydrophobic finish on at least one surface of the cementitious core. This also discloses a method comprising (a) preparing an aqueous siloxane dispersion, wherein the dispersion comprises about 4 wt. % to about 8 wt. % siloxane, (b) combining the siloxane dispersion with a cementitious mixture to provide a cementitious slurry, (c) depositing the cementitious slurry onto a substrate, and (d) allowing the cementitious slurry to harden, thereby providing a cementitious article.

US 2022/0411330 to Blades et al. discloses a gypsum board comprising a gypsum core and a glass mat facing material including a coating. The coating comprises a resin including an acrylic resin, a siloxane rubber, or a mixture thereof and hydrophobic additive comprising an organosilane.

U.S. Pat. No. 5,817,262 A to Englert, incorporated herein by reference in its entirety, discloses a process for making a gypsum wood fiber board with improved moisture resistance through addition of an aqueous siloxane emulsion to the calcined gypsum and wood fiber slurry at a temperature above the point at which the hemihydrate will rehydrate to gypsum.

U.S. Pat. No. 6,221,521 B1 to Lynn, incorporated herein by reference in its entirety, discloses a three layer paperless fiber reinforced gypsum/fiberboard product that is non-combustible and which uses no more than 3% by weight organic material in its core layer and 10-30% paper reinforcing fiber added to calcined gypsum in its surface layers.

U.S. Pat. No. 6,406,779 B1 to Carbo et al., incorporated herein by reference in its entirety, discloses a paperless gypsum/fiberboard made with calcined gypsum and added cellulose fiber with improved surface characteristics by addition of a heat curable primer comprising an aqueous emulsion of a film forming polymeric material.

US2007/0056478 to Miller et al., incorporated herein by reference in its entirety, discloses an improved method for making a water resistant gypsum fiberboard that comprises adding a silicone compound and magnesium oxide to a calcined slurry of calcium sulfate hemihydrate and cellulose fiber after the calcination step and before dewatering the slurry to form a filter cake.

WO 2020/225746 to Yuan et al. discloses a gypsum panel comprising a gypsum core comprising set gypsum and a colloidal material comprising colloidal silica, colloidal alumina, or both. It discloses gypsum panels or boards may contain a set gypsum core between two mats, none, one, or both of which may be coated. The mat coating may be a substantially continuous barrier coating.

U.S. Pat. No. 7,918,950 to Skinner et al. describes a process for making a gypsum fiber board panel. An example composition disclosed at TABLE 2 has a gypsum fiber core having about 1.0 wt. % siloxane.

### SUMMARY OF THE INVENTION

The present invention relates to an improved gypsum fiberboard. The gypsum fiber board panel (GFP) according to the present invention has a different structure than a paper or fiberglass faced, gypsum core panel. The GFP base panel has composition that is primarily gypsum and paper fiber with other smaller dosed performance additives such as siloxane for water resistance performance and has no facer component. The GFP has no facer mat or mesh on its surface. The GFP has no embedded mat or mesh.

In particular the invention provides a gypsum fiber panel (also referred to in the present disclosure as a “gypsum fiber board panel”, “gypsum fiberboard panel” or “GFP”) comprising:
a fiber-reinforced gypsum board core layer comprising:
   gypsum,
   cellulose fibers embedded uniformly throughout the core layer,
   a siloxane level of 0 to about 1.0 wt. %, typically about 0.1 to about 0.9 wt. %, preferably about 0.2 to about 0.8 wt. %, more preferably about 0.2 to about 0.8 wt. %, furthermore preferably about 0.3 to about 0.6 wt. %, most preferably about 0.25 to about 0.50 wt. % uniformly distributed within the gypsum board core layer; and
a hydrophobic coating on the core layer, wherein the hydrophobic coating comprises as ingredients:
a film forming polymer, and
at least one of:
   a non-setting inorganic filler, having a volume mean particle diameter of about 4 microns to about 100 microns, preferably about 6 microns to about 80 microns, more preferably about 8 microns to about 60 microns, most preferably about 10 microns to about 40 microns, and a hydraulic component comprising a fly ash,
wherein, if the hydraulic component is present, the hydrophobic coating further comprises at least one member of the group consisting of:
   an extended flow time retention agent comprising at least one member selected from the group consisting of carboxylic acids, salts of carboxylic acids, and mixtures thereof, and
   optionally a silane;
wherein the gypsum fiber panel has no facer mat or mesh on its surface;
wherein the gypsum fiber panel has no embedded mat or mesh.

In particular the invention also provides a method for making the gypsum fiber panel (GFP) of the invention comprising:
providing an aqueous slurry comprising gypsum and a first portion of cellulose fibers to a reactor, reacting the gypsum and a first portion of cellulose fiber in a reactor to produce a calcined crystalline gypsum and cellulose fiber slurry,
adding to the first slurry a second portion of cellulose fiber slurry after the reactor step to form a second slurry,
depositing the second slurry to form a mat,
dewatering the mat,
rehydrating the mat to a gypsum cellulose fiber mat,
then drying the gypsum cellulose fiber mat,
cutting the gypsum cellulose fiber mat into a final gypsum fiber panel, and
applying the hydrophobic coating after drying to the gypsum cellulose fiber mat or applying the hydrophobic coating after cutting to the final gypsum fiber panel.

The board core of the invention includes 0 to about 1.0 wt. %, typically about 0.1 to about 0.9 wt. %, preferably about 0.2 to about 0.8 wt. %, more preferably about 0.2 to about 0.8 wt. %, furthermore preferably about 0.3 to about 0.6 wt. %, most preferably about 0.25 to about 0.50 wt. % siloxane uniformly distributed within the gypsum board core. The siloxane level in the core, together with the addition of a hydrophobic coating, has led to a surprising increase in surface water absorption resistance. This led to a board that meets the ANSI waterproofness standard for water column performance (A118.10 American National Standard Specifications for Load Bearing, Bonded, Waterproof Membranes for Thin-set Ceramic Tile and Dimension Stone Installation, revised 2014). Meeting the ANSI A118.10 waterproofness standard means providing water penetration resistance through the panel thickness for a 24-inch head of water for 48 hours duration. Furthermore, the coated panel products of the invention demonstrate no drop in water level in the 24-inch head of water column after 48 hours duration subsequent to the start of the test.

In the present disclosure use of the transitory phrase “comprising” is deemed to also disclose the transitory phrases “consisting essentially of” or “consisting of” and vice versa.

### BRIEF DESCRIPTION OF THE DRAWINGS

FIG. 1 is a diagram of a perspective view of an embodiment of the gypsum cellulose fiber panel of the present invention.

FIG. 1A is a diagram of a side view of the embodiment of the gypsum cellulose fiber panel of FIG. 1.

FIG. 2 is a schematic diagram of an embodiment of the method of producing the gypsum fiber board panel of the invention.

FIG. 3 is a schematic side view illustrating a roller assembly comprising a finish roller with circumferential grooves defined therein applying a non-setting, hydrophobic finish to a mat-faced cementitious board with the assembly in a direct finish orientation, in accordance with embodiments of the invention.

FIG. 4 is a front schematic view of the roller assembly taken along the line IV-IV depicted in FIG. 3.

FIG. 5 is a schematic side view illustrating a roller assembly comprising a finish roller with circumferential grooves defined therein applying a non-setting, hydrophobic finish to a mat-faced cementitious board with the assembly in a reverse finish orientation, in accordance with embodiments of the invention.

FIG. 6 is a front schematic view of the roller assembly taken alone the line VI-VI depicted in FIG. 5.

### DETAILED DESCRIPTION OF THE PREFERRED EMBODIMENTS

### A. The Panel

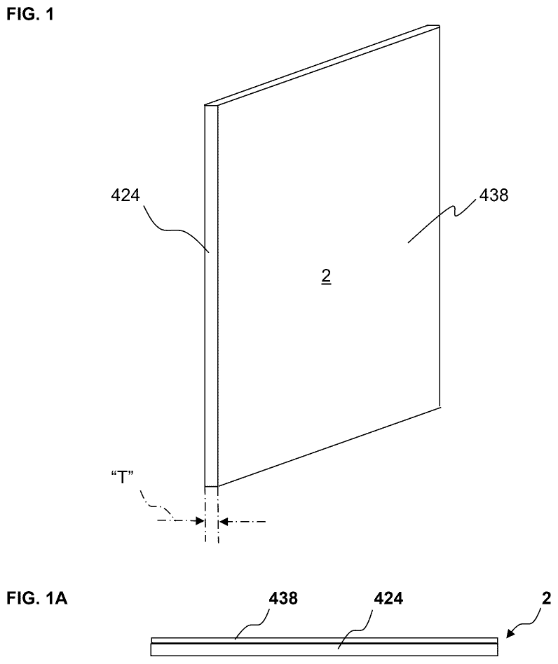

Contemplated present invention gypsum products include, but are not limited to, panels, boards, tiles, ceiling tiles and products of various custom-designed shapes. Typically the present invention relates to a coated and reinforced, dimensionally stable gypsum cellulose fiber board panel. The terms panel and board are interchangeable. FIG. 1 shows a perspective view of a panel 2 of the present invention having a core 424 with a hydrophobic coating 438 coated on a surface of the core 424. FIG. 1A is a diagram of a side view of the embodiment of the gypsum cellulose fiber panel 2 of FIG. 1 having the core 424 and the hydrophobic coating 438. The hydrophobic coating may be applied as a liquid either to the panel front surface, or to the panel back surface, or to both the panel front and back surfaces. Preferably, the coating is applied only to one surface of the panel. Most preferably, the coating is applied to the panel front surface. The coating may be applied in a single layer (pass), two layers (passes), or more than two layers (passes). When two or more coating layers are utilized, the individual coating layers may be applied to the panel surface in a single orientation, or they may be applied in different orientations, for example, adjacent coating layers may be applied at a 90° angle with respect to each other. Preferably, the coating is applied in one layer (pass) only. Preferably, the coating is applied in the machine direction on a continuous manufacturing line.

The total thickness “T” of the panel 2 typically ranges from ¼ inch to 1 inch.

In particular the invention provides a gypsum fiber panel (GFP) comprising:
a fiber-reinforced gypsum board core layer comprising:
   gypsum,
   cellulose fibers embedded uniformly throughout the core layer,
   a siloxane level of 0 to about 1.0 wt. %, typically about 0.1 to about 0.9 wt. %, preferably about 0.2 to about 0.8 wt. %, more preferably about 0.2 to about 0.8 wt. %, furthermore preferably about 0.3 to about 0.6 wt. %, most preferably about 0.25 to about 0.50 wt. % uniformly distributed within the gypsum board core layer; and
a hydrophobic coating on the core layer, wherein the hydrophobic coating comprises as ingredients:
a film forming polymer, and
at least one of:
   a non-setting inorganic filler, having a volume mean particle diameter of about 4 microns to about 100 microns, preferably about 6 microns to about 80 microns, more preferably about 8 microns to about 60 microns, most preferably about 10 microns to about 40 microns, and
   a hydraulic component comprising a fly ash,
wherein, if the hydraulic component is present, the hydrophobic coating further comprises at least one member of the group consisting of:
   an extended flow time retention agent comprising at least one member selected from the group consisting of carboxylic acids, salts of carboxylic acids, and mixtures thereof, and
   optionally a silane;
wherein the gypsum fiber panel has no facer mat or mesh on its surface;
wherein the gypsum fiber panel has no embedded mat or mesh.

The panel includes a continuous phase resulting from the curing of an aqueous mixture of gypsum and cellulosic fibers, the panel comprising, on a dry basis, 95-70 wt. % gypsum, 5-10 wt. % uniformly distributed cellulosic fiber, a uniformly distributed siloxane level of 0 to about 1.0 wt. %, typically about 0.1 to about 0.9 wt. %, preferably about 0.2 to about 0.8 wt. %, more preferably about 0.2 to about 0.8 wt. %, furthermore preferably about 0.3 to about 0.6 wt. %, most preferably about 0.25 to about 0.50 wt. %, distributed within the gypsum board core layer, and about 0 to 3 wt. % unhydrated hemihydrate (“UHH”).

The principal starting materials used to make panels of the invention are inorganic binder, e.g., alpha calcium sulfate alpha hemihydrate, cellulosic fiber from “host particle”, water, and optional additives as well as the added cellulose fiber added to the slurry comprising calcined gypsum before the slurry is formed into a mat. For purposes of this disclosure, the term gypsum slurry covers a slurry comprising gypsum fed to a calcining reactor, a slurry comprising calcined gypsum, and this slurry as the calcium sulfate hemihydrate of the calcined gypsum sets to form calcium sulfate dihydrate.

In many applications, for example in siding, the panels will be nailed or screwed to vertical framing

Advantageously the panel provides a water resistant panel of lightweight density. The density of the core layer of the panel is typically 56 to 90 lbs. per cubic foot, preferably 60 to 70 lbs. per cubic foot. The coating adds minimal additional weight. The areal density of the nominal ½″ thick panels (total core and coating) is typically 2370 to 3900 lbs./MSF, preferably 2540 to 3000 lbs./MSF. The aerial density of the coating is typically 40 to 200 lbs./MSF, preferably 50 to 100 lbs./MSF. The coating is applied in an amount of 30 to 200-lbs./msf, preferably 35 to 150 lbs./msf, more preferably 40 to 125 lbs/msf, most preferably 45 to 100 lbs/msf. These coating weights are on wet (water inclusive) basis (as applied on the board).

Other methods of depositing a mixture of the slurry and adding cellulose fibers will occur to those familiar with the panel-making art. For example, rather than using the present continuous process of making panel on a continuous sheet, a batch process could also be used to make panels in a similar manner, which after the material has sufficiently set, can be cut into panels of the desired size.

### B. Formulation

The components of the core layer of the panels of the invention are calcium sulfate dihydrate, siloxane, paper or other cellulose fibers, alpha calcium sulfate alpha hemihydrate, and water. On a dry (water free) basis, the components used to make the panels of the invention include a siloxane provided at a level of 0.7 to 1.0 wt. %, typically 0.75 wt. %. The cellulose fibers and siloxane are uniformly distributed within the gypsum board core layer.

Small amounts of binders, accelerators and/or retarders may be added to the composition to control the setting characteristics of the green (i.e., unhydrated) material such as calcium sulfate hemihydrate (“UHH”). Typical non-limiting additives include setting accelerators for alpha calcium sulfate hemihydrate such as gypsum.

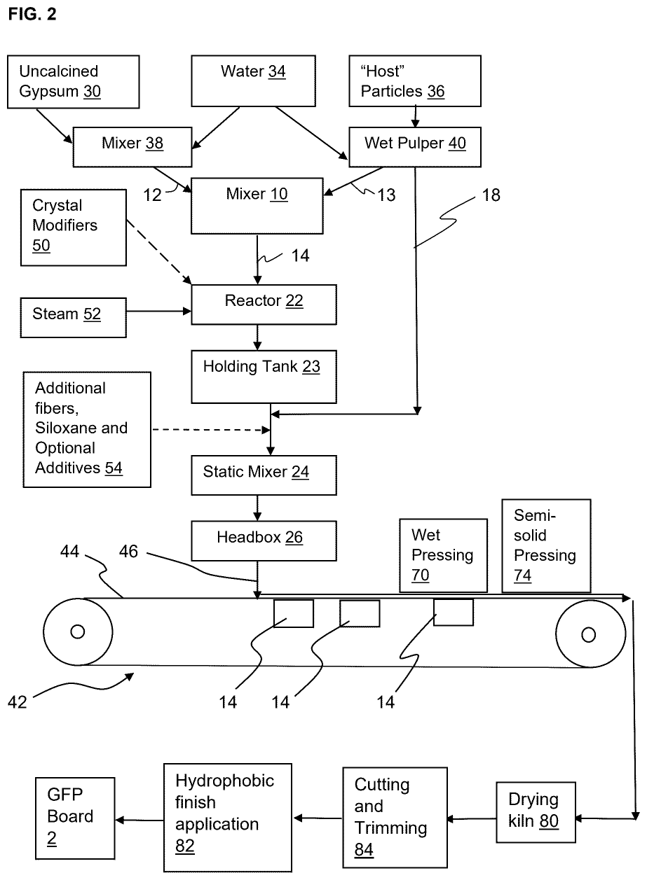

Panels of the invention include a continuous phase in which the cellulose fibers and the siloxane are uniformly distributed. As shown in FIG. 2, the continuous phase results from the curing of an aqueous mixture of the calcined gypsum and cellulose fibers from a pressurized reactor and an aqueous slurry of additional cellulose fibers introduced into the gypsum fiber slurry after it leaves the reactors, and introducing the siloxane into the gypsum fiber slurry after it leaves the reactors, and then feeding the gypsum slurry to a slurry headbox, where it is fed to the forming belt at a temperature of about 180°-200° F. at atmospheric pressure.

Typical broad weight proportions of embodiments of the formulations of the core layer of the invention, based on dry weight, are shown in TABLE 1, below.

TABLE 1
Formulations of the core layer

| Typical Mixture Weight Proportions | Broad | Typical | More Typical |
|---|---|---|---|
| on Dry (water free) Basis | Range Wt. % | Range Wt. % | Range Wt. % |
| Gypsum | 70-93 | 90-93 | 90-92 |
| Siloxane | 0 to 1.0 | 0.1 to 0.9 | 0.2 to 0.8 |
| Cellulose Fibers Added To | 2-14 | 2.5-7 | 3-6 |
| Gypsum Before Calcination | | | |
| Cellulose Fiber Added To Slurry | 2-14 | 2.5-8 | 3-6 |
| After Leaving Calcination Reactor | | | |
| TOTAL Cellulose Fiber | 4-20 | 5-15 | 6-12 |
| Unhydrated hemihydrate (“UHH”) | 0-10 | 0-3 | 0-3 |
| Additives | 0-2 | 0-2 | 0-2 |
| Totals | 100 | 100 | 100 |

The dry ingredients of the composition include gypsum, cellulose fibers, and siloxane and the wet ingredients of the composition include water. The dry ingredients and the wet ingredients are combined to produce the panel of the invention. The cellulose fibers added to the gypsum cellulose fiber leaving the reactor are uniformly distributed in the matrix throughout the full thickness of the panel. Typically a first portion of cellulose fiber is added before the calcination and a second portion of cellulose fiber, typically at least half of the total cellulose fibers in the final panel is added after the gypsum cellulose slurry emerges from the reactor. In a typical embodiment, the panel would be formed from about 90 to 92 wt. % gypsum, about 0.2 to about 0.8 wt. % siloxane, and about 5 to about 15 wt. % cellulose fiber, on a dry ingredient basis.

### 1. Calcium Sulfate Hemihydrate

The term gypsum, as used herein, means calcium sulfate in the stable dihydrate state, i.e., CaSO₄·2 H₂O, and includes the naturally occurring mineral, the synthetically derived equivalents, and the dihydrate material formed by the hydration of calcium sulfate hemihydrate (stucco, also known as calcined gypsum) or anhydrite. The term “calcium sulfate material”, as used herein, means calcium sulfate in any of its forms, namely calcium sulfate anhydrite, calcium sulfate hemihydrate, calcium sulfate dihydrate and mixtures thereof.

Unless otherwise indicated, “gypsum” will refer to the dihydrate form of calcium sulfate. The raw gypsum is thermally processed to form a settable calcium sulfate, which typically is the hemihydrate, CaSO₄·1/2 H₂O. The settable calcium sulfate reacts with water to solidify by forming the dihydrate (gypsum). The hemihydrate has two recognized morphologies, termed alpha hemihydrate and beta hemihydrate. These are selected for various applications based on their physical properties and cost. Both forms react with water to form the dihydrate of calcium sulfate, typically with large aspect ratio. The alpha hemihydrate forms more dense microstructures having higher strength and density than those formed by the beta hemihydrate. Thus, the alpha hemihydrate could be substituted for beta hemihydrate to increase strength and density or they could be combined to adjust the properties.

Typically the inorganic binder used to make panels of the present invention comprises a blend containing alpha calcium sulfate hemihydrate, siloxane, and lignocellulosic fiber from paper, such as Kraft paper, waste paper, etc.

### 2. “Host Particle”

The term host particle is meant to cover any macroscopic particle as a fiber, a chip, or a flake, of a substance other than gypsum. The particle, which is generally insoluble in the slurry liquid, should also have accessible voids therein; whether pits, cracks, fissures, hollow cores, or other surface imperfections, which are penetrable by the slurry menstruum and within which calcium sulfate crystals can form. The substance of the host particle should have desirable properties lacking in gypsum, and preferably at least higher tensile and flexural strength. A ligno-cellulosic fiber, particularly a paper fiber, is an example of a host particle. Therefore, without intending to limit the material and/or particles that are suitable as host particles, paper fiber is often used hereinafter for convenience in place of the broader term.

### 3. Gypsum/Cellulose Fiber

The term gypsum fiberboard or gypsum fiber panel (GFP), as used herein is meant to cover mixtures of gypsum and host particles including cellulose fibers, e.g., paper fibers, which are used to produce boards wherein at least a portion of the gypsum is in the form of acicular calcium sulfate dihydrate crystals positioned in the voids of the host particles, wherein the dihydrate crystals are formed in situ by the hydration of acicular calcium sulfate hemihydrate crystals in and about the voids of the particles. The gypsum fiber boards are produced by a process shown in FIG. 2, which is a modified version of the process for making a gypsum fiberboard in U.S. Pat. No. 7,918,950 to Skinner et al.

Typically the cellulose fibers are available in the large pieces that are wet pulped into a uniform slurry of about 4% by weight solids.

### 4. Siloxane

The panel core also comprises a siloxane as a hydrophobic agent, in a suitable amount to improve the water resistance of the core material. It is also preferred that the cementitious core comprise a siloxane catalyst, such as magnesium oxide (e.g., dead burned magnesium oxide), fly ash (e.g., Class C fly ash), or a mixture thereof. However, the invention may also have an absence of magnesium oxide in the panel core and/or coating. The siloxane and siloxane catalyst can be added in any suitable amount, and by any suitable method as described herein with respect the method of preparing the board of the invention, or as described, for example, in U.S. Patent Publications 2006/0035112 A1 or 2007/0022913 A1.

Various siloxane compounds which are capable of forming a polymer/resin, also known as a polysiloxane with general formula (R₂SiO) n, wherein n is a number of times the R₂SiO unit is repeated in a polymer, R can be any organic group, including vinyl (CH₂), methyl (CH₃), and phenyl (C₆H₅), can be used for forming a polymeric matrix in a gypsum product. Suitable organosiloxanes may further include organohydrogensiloxanes which comprise Si-bonded hydrogen. Suitable organohydrogensiloxanes include methylhydrogensiloxane available under trade name from Wacker Chemical Corporation or Dow Corning Chemical.

Typically the siloxane has a viscosity of above 30 cps when measured in accordance to DIN 51562 standard. Preferably the siloxane has a viscosity of 30 cps to 242 cps. At least in some embodiments, the siloxane is a high molecular weight hydrogen modified siloxane, such as polymethylhydrogen siloxane, with viscosity of at least 36 cps, or at least 40 cps, or at least 50 cps, or at least 80 cps, or in the range from 60 cps to 80 cps, and adapted to be polymerized into silicone. In some embodiments, the siloxane has viscosity above 36 cps, or above 40 cps, or above 50 cps or in a range from 60 to 80 cps.

The concentration of siloxane in the gypsum slurry may range from 0 to about 1.0 wt. %, typically about 0.1 to about 0.9 wt. %, preferably about 0.2 to about 0.8 wt. %, more preferably about 0.2 to about 0.8 wt. %, furthermore preferably about 0.3 to about 0.6 wt. %, most preferably about 0.25 to about 0.50 wt. %, based on the weight of the gypsum slurry on a dry (water free) basis.

Typically the method of preparing a water-resistant cementitious article comprises (a) preparing an aqueous siloxane dispersion, wherein the dispersion comprises about 1 wt. % to about 5 wt. % siloxane, (b) combining the siloxane dispersion with the gypsum slurry.

### 5. Accelerator of Siloxane Polymerization

Optionally the composition of the gypsum layer includes at least one accelerator of siloxane polymerization. Various accelerators can be added to initiate polymerization of siloxane in a gypsum product. Such accelerators include, but are not limited to, magnesium oxide or magnesium hydroxide. The siloxane polymerization accelerators can be used in various concentrations. In some embodiments, a siloxane polymerization accelerator is used in a concentration from 0.01% to 0.0.5 wt. % based on the weight of the gypsum slurry on a dry (water free) basis.

### 6. Other Additives for the Core Layer

The additives for the core can be any additives commonly used to produce “gypsum fiber board panels”. Such additives include, without limitation, structural additives such as mineral wool, continuous or chopped glass fibers (also referred to as fiberglass), perlite, clay, vermiculite, calcium carbonate, polyester, and paper fiber, as well as chemical additives such as foaming agents, fillers, accelerators, sugar, enhancing agents such as phosphates, phosphonates, borates and the like, retarders, binders (e.g., starch and latex), colorants, fungicides, biocides, and the like.

Desirably, the “gypsum fiber board panels” core layer may comprise strength-improving additives, such as phosphates (e.g., polyphosphates as described in U.S. Pat. Nos. 6,342,284, 6,632,550, and 6,800,131 and U.S. Patent Publications 2002/0045074 A1, 2005/0019618 A1, and 2007/0022913 A1) and/or pre-blended unstable and stable soaps (e.g., as described in U.S. Pat. Nos. 5,683,635 and 5,643,510).

### B. Making a Panel of the Present Invention

In the process, uncalcined gypsum, siloxane, and a first portion of the host particle, e.g., paper fiber, are mixed together with sufficient liquid to form dilute slurry which is then heated under pressure with steam to calcine the gypsum, converting it to an alpha calcium sulfate hemihydrate. Crystal modifiers can be added to the slurry if desired. The resulting composite is a host particle physically interlocked with calcium sulfate crystals. A plurality of such composite particles form a material mass which can be compacted, pressed into boards, cast, sculpted, molded, or otherwise formed into desired shape prior to final set. According to a preferred embodiment of the invention, the host particle is a paper fiber. The mixture is then deposited on a dewatering conveyor, formed, dried, and typically cut and trimmed to form a board. Then a hydrophobic finish is applied to the board and the coating is cured. The term “curing” encompasses setting and/or drying.

The following describes details of the various process steps.

### 1. Mixing Slurry

Referring to FIG. 2, the paper, from a source of Host particles 36, is first pulped in a wet pulper 40 and then mixed with water from a source of water 34 to form uniform aqueous fiber slurry 13 containing about 3% to 4.5%, by weight (based on the total solids).

The host particle is preferably a cellulosic fiber which may come from waste paper, wood pulp, wood flakes, and/or another plant fiber source. Preferably the fiber is porous, hollow, split and/or rough surfaced such that its physical geometry provides accessible interstices or voids which accommodate the penetration of dissolved calcium sulfate. In any event the source, for example, wood pulp, may also require prior processing to break up clumps, separate oversized and undersized material, and, in some cases, pre-extract strength retarding materials and/or contaminants that could adversely affect the calcination of the gypsum; such as hemi-celluloses, acetic acid, etc.

Referring again to FIG. 2, ground, uncalcined gypsum, from a source of uncalcined gypsum 30, is mixed with enough water, from the source of water 34, in a mixer 38 to form aqueous gypsum slurry 12 having about 65%-85% by weight water. The gypsum is typically from raw ore or a by-product of a flue gas desulphurization. The gypsum should be of a relatively high purity, i.e., preferably 70-98 wt. % calcium sulfate dihydrate, and finely ground, for example, to 92-96 wt. % minus 100 mesh to minus 200 mesh or smaller. Larger particles may lengthen the conversion time. The gypsum from uncalcined gypsum source 30 is typically introduced to the mixer 10 as an aqueous slurry (as shown in FIG. 2) but can be introduced as a dry powder.

The slurries of ground gypsum 12 and pulped paper 13 are then blended together with sufficient water in a mixer 10 equipped with an agitator (not shown) to form a homogeneous composite gypsum slurry 14. The aqueous ground gypsum slurry 12 is typically 40% by weight solids. The uniform cellulose fiber, e.g., paper fiber, slurry 13, is typically at about 4% consistency. The composite gypsum slurry 14 typically contains about 15-35% by weight solids. The solids in the composite gypsum slurry 14 typically comprise from about 0.5% to 5.0% by weight of cellulose fibers and the balance being mainly gypsum.

### 2. Conversion to Hemihydrate

Then the homogeneous composite gypsum slurry 14 is fed to a reactor system (pressure vessel) 22 for calcining the gypsum. Thus, the gypsum supplied to the reactor 22 is in the form of an aqueous slurry and the first portion of cellulose fiber that is added to the reactor is also in the form of an aqueous slurry and the two slurries were blended together before entering the reactor 22. The method of claim 1 wherein the first portion of cellulose fiber is about 3.0 wt % to 4.5 wt % of the aqueous slurry on a dry basis prior to entering the reactor 22. The consistency of the gypsum and cellulose fiber slurry in the reactor is about 25% to 30% by weight. Typically no more than one half of the total cellulose fiber in the final panel is added in the first portion to the reactor for calcination with the gypsum.

The invention co-calcines gypsum and cellulose fiber slurry by any suitable process. A typical process for making such composite slurry is disclosed by U.S. Pat. No. 5,320,677, incorporated herein by reference in its entirety.

The reactor 22 is typically a pressure vessel(s) or autoclave(s) equipped with a continuous stirring or mixing device. Steam from a source of steam 52 is fed to the reactor 22 such that the slurry is heated in the reactor 22 at a temperature sufficient to convert the gypsum to calcium sulfate hemihydrate. Steam is injected into the reactor vessel 22 to bring the interior temperature of the vessel up to between about 100° C. (212° F.) and about 177° C. (350° F.), and up to 70 psig for saturated steam; the lower temperature being approximately the practical minimum at which the calcium sulfate dihydrate will calcine to the hemihydrate state within a reasonable time; and the higher temperature being about the maximum temperature for calcining hemihydrate without risk of causing some the calcium sulfate hemihydrate to convert to anhydrite. The reactor vessel temperature is preferably on the order of about 121 C. (250° F.) to 152° C. (305° F.). It is desirable to continuously agitate the slurry in the reactor 22 with gentle stirring or mixing to break up any fiber clumps and keep all the particles in suspension. If desired, crystal modifiers, such as organic acids, can be added to the slurry at this point, from a source of crystal modifiers 50, and may also be fed to the reactor 22. The crystal modifiers, if present, stimulate or retard crystallization or to lower the calcining temperature.

In the reactor (pressure vessel) 22 the hemihydrate precipitates out of solution and forms acicular alpha hemihydrate crystals. When the slurry is processed under these conditions for a sufficient period of time, for example on the order of 18 to 23 minutes, enough water will be driven out of the calcium sulfate dihydrate molecule to convert it to the hemihydrate molecule.

Typically the time for calcining the gypsum and first portion of cellulose fiber is about 15 to 25 minutes. More typically, the time for calcining the gypsum and first portion of cellulose fiber is about 18 to 22 minutes.

The solution, aided by the continuous agitation to keep the particles in suspension, will wet out and penetrate the open voids in the host particles. As saturation of the solution is reached, the hemihydrate will nucleate and begin forming crystals in, on, and around the voids and along the walls of the host fibers.

It is believed that during the autoclaving reaction operation, the dissolved calcium sulfate penetrates into the voids in the cellulose fibers and subsequently precipitates as acicular hemihydrate crystals within, on and about the voids and surfaces of the cellulose-fibers. When the conversion is complete, the pressure on the autoclave is reduced, any desired additives, including wax emulsion, can be introduced, typically at or before the head box 26, and the slurry 46 is discharged from the reactor 22.

The pressure on the product slurry is relieved when the slurry is discharged from the reactor 22, to a holding tank 23. The balance of the “host” fibers (“pulped paper”), i.e., the second portion of host fibers, siloxane, and other optional ingredients are added to the gypsum fiber slurry, discharged from the holding tank, together or separately from one or more sources of additional fibers, siloxane and optional additives 54 (one source shown), and fed to a static mixer 24. The host fibers are typically cellulose fibers, e.g., paper fibers. The added ingredients can include selected process modifying or property enhancing additives, such as accelerators, retarders, weight reducing fillers, water resistance additives, etc.

Typically the second portion of cellulose fiber is added to the calcined gypsum and cellulose fiber slurry in the form of an aqueous slurry. About 50 wt % to 70 wt % of the total cellulose fiber is added as the second portion to the calcined gypsum and cellulose fiber slurry after the slurry leaves the reactor 22.

Preferably the siloxane is added in the form of an emulsion or dispersion to the gypsum slurry. Preferably, a high-viscosity siloxane dispersion is mixed with a gypsum slurry as described in U.S. Pat. No. 7,413,603, incorporated herein by reference. Various accelerators can be added to initiate polymerization of siloxane in a gypsum product. Such accelerators include, but are not limited to, magnesium oxide. The siloxane polymerization accelerators can be used in various concentrations. In some embodiments, a siloxane polymerization accelerator is used in a concentration from 0.01% to 0.5%.

Conventional optional additives include accelerators, such as calcined gypsum setting accelerators, which are other than the accelerators added to initiate polymerization of siloxane in a gypsum product, setting retarders, preservatives, fire retardants, water resistant core additives and strength enhancing agents.

While still hot, the resulting product slurry 46 from the static mixer 24 is fed to a head box 26 and then discharged through the head box 26 onto a forming screen 44 of a dewatering conveyor (continuous felting conveyor) 42, such as the type used in paper making operations, to form a filter cake and remove as much uncombined water as possible. The forming screen 44 is a porous endless belt.

The cellulose fibers and siloxane are uniformly distributed in the gypsum cellulose fiber slurry discharged from the head box 26. It is preferred that the second portion of host fibers, siloxane, and other optional ingredients be added to the slurry at the entry to the static mixer prior to the headbox. However, the second portion of host fibers, siloxane, and other optional ingredients may be added to the gypsum fiber slurry in the headbox provided that the second portion of host fibers, siloxane, and other optional ingredients are uniformly dispersed in the product slurry 46 prior to being deposited on the dewatering conveyor 42.

### 3. Dewatering

The added cellulose fiber and calcined gypsum fiber slurry 46 is passed through the head box 26 which distributes the slurry onto the surface of the flat forming screen (porous belt) 44 to produce a filter cake as a layer of gypsum paper fiber slurry on the forming screen 44 of the felting dewatering conveyor 42.

The filter cake is dewatered by the water in the slurry passing through the porous surface of the forming screen 44, preferably aided by vacuum from one or more vacuum stations 14. As much as 90% of the water can be removed from the filter cake by the felting dewatering conveyor 42. As a consequence of the water removal and air pulled through the formed mat through vacuum boxes 14, the filter cake is cooled to a temperature at which rehydration may begin. However, it may still be necessary to provide additional external cooling to bring the temperature low enough to accomplish the rehydration within an acceptable time.

Although the dewatering causes cooling of the filter cake, additional external cooling may be applied during the dewatering step.

As much of the water is removed as possible through pressing through rollers in the wet pressing while the temperature of the product slurry is still relatively high and before the hemihydrate is substantially converted into gypsum. As much as 90% of the slurry water is removed in the dewatering device, leaving a filter cake of approximately 35% water by weight. At this stage the filter cake preferably consists of cellulose fibers interlocked with rehydratable calcium sulfate hemihydrate crystals and can still be broken up into individual composite fibers or nodules, shaped, cast, or compacted to a higher density.

### 4. Pressing and Rehydration

Before extensive rehydration takes place, the filter cake is preferably consolidated into a board of desired thickness and/or density. If the board is to be given a special surface texture or a laminated surface finish, it would preferably occur during or following this step of the process. The dewatered filter cake is preferably first wet-pressed using suction rolls (not shown) and then presses in a semi-solid pressing step to further reduce the water content and to compact the filter cake into the desired shape, thickness and/or density before substantial rehydration of the hemihydrate occurs.

During the wet pressing at wet pressing station 70, which preferably takes place with gradually increasing pressure to preserve the product's integrity, additional water, e.g., about 50-60% of the remaining water, is removed. The mat is then further pressed in a semisolid dry pressing step at semi-solid pressing station 74. The semi-solid pressing further dewaters and consolidates the mat under the combined effect of vacuum and pressure to a moisture content (wet basis) of about 25 wt. % to about 35 wt. %, (30-55 wt. % on a dry basis) and typically a temperature of about 93.3° C. (200° F.). The term “wet basis” when used in this specification means based on the composition including water.

The spacing between the primary wet pressing and a secondary semi-solid pressing is used to impart smoothness, depending upon the belt surface used. The semi-solid pressing also decreases thickness variation by setting it at a fixed-gap nip slightly less than the desired end result board thickness.

As a consequence of the additional water removal, the filter cake is further cooled to a temperature at which rapid rehydration occurs. However, although the extraction of the bulk of the water in the dewatering step will contribute significantly to lowering the filter cake temperature, additional external cooling may be required to reach the desired rehydration temperature within a reasonable time. The temperature of the filter cake is preferably reduced to below about 49° C. (120° F.) so that relatively rapid rehydration can take place. The rehydration recrystallizes the alpha hemihydrate crystals into acicular gypsum crystals in place, physically interlocked with the cellulose fibers.

The calcium sulfate hemihydrate hydrates to calcium sulfate dihydrate, so that the acicular calcium sulfate hemihydrate crystals are converted to gypsum crystals comprising calcium sulfate dihydrate in situ in and around the cellulose fibers.

Depending on the accelerators, retarders, crystal modifiers, or other additives provided in the slurry, hydration may take from only a few minutes to an hour or more. Because of the interlocking of the acicular crystals with the cellulose fibers, and the removal of most of the carrier liquid from the filter cake, migration of the calcium sulfate is averted, leaving a homogeneous composite. The rehydration effects recrystallization of the hemihydrate crystals to dihydrate crystals in situ, i.e. within and about the voids of the cellulose fibers, thereby preserving the homogeneity of the composite. The crystal growth also connects the calcium sulfate crystals on adjacent fibers to form an overall crystalline mass, enhanced in strength by the reinforcement of the cellulose fibers. The rehydration is the reaction for the setting of the board.

Typically the mat formed sets within about 15-25 minutes of formation and rehydration.

### 5. Drying, Cutting and Trimming

After at least some, or complete, rehydration, the boards can be dried in a drying kiln 80 to remove the remaining free water to develop maximum physical properties. Preferably, the drying temperature is kept low enough to avoid recalcining any gypsum on the surface. The pressed board, which typically contains about 30% by weight of free water, is then promptly dried at a relatively high temperature in order to reduce the free water content to about 0.5% or less in the final product. Drying conditions which tend to calcine the gypsum should be avoided. It is desirable to carry out the drying under conditions in which the product achieves a core temperature of no more than 93.3° C. (200° F.), preferably no more than about 74° C. (165° F.), so that recalcination of the gypsum does not occur. The set and dried board can be cut and otherwise finished to desired specification.

When finally set, the unique composite material exhibits desired properties contributed by both of its two components. The cellulose fibers increase the strength, particularly flexural strength, of the gypsum matrix, while the gypsum acts as a coating and binder to protect the cellulose fiber, impart fire resistance and decrease expansion due to moisture.

Then the set and dried board is cut and trimmed in cutting and trimming station 84, if desired.

Typically the density of the set and dried board is about 53 to 70 pounds per cubic foot. Typically the final gypsum cellulose fiberboard comprises, on a dry basis, 90-94 wt. % gypsum, 6-10 weight % cellulosic fiber and about 0.0 to 3.0 weight % of unhydrated hemihydrate. The continuous phase of the set and dried board comprises a co-calcined gypsum cellulose fiber crystalline slurry which is uniformly reinforced with cellulose fibers added in a second portion to the calcined gypsum cellulose fiber crystalline slurry after the calcination step and including the siloxane.

### 6. Application of Hydrophobic Coating

When applied the hydrophobic coating composition is a liquid (also termed herein as the hydrophobic finish or hydrophobic finish composition). Then it dries/sets (cures) to form a solid hydrophobic coating layer. The hydrophobic coating is applied after drying/setting (curing) to the gypsum cellulose fiber mat or the hydrophobic coating is applied after cutting to the final gypsum fiber panel. Coating may be applied either before board trimming or after board trimming. Coating may be applied in line in the process or it may be applied off-line in a two-stage process. The coating may be applied in a single pass or double passes, or multiple passes. Preferably coating is applied in a single pass. Alternative methods of coatings may also be utilized such as screeding, spraying, knife coating or curtain coating. The hydrophobic coating composition is applied in an amount of 30 to 200 lbs./msf, preferably 35 to 150 lbs./msf, more preferably 40 to 125 lbs/msf, most preferably 45 to 100 lbs/msf. These are the amounts of the liquid hydrophobic coating composition on the board. The hydrophobic coating composition typically has out 5 to about 35%, preferably about 5 to about 30%, by weight water; and a remainder that is the ingredients that will become the hydrophobic coating upon curing.

In an embodiment as shown in FIG. 2 after the board is cut and trimmed, a hydrophobic finish is applied as a coating to at least one side of the board at hydrophobic finish application station 82 and the coating cured (set and/or dried) to produce the GFP board 2. In an alternative, not shown, after drying in drying kiln 80, but before the board is cut and trimmed, the hydrophobic finish is applied as a coating to at least one side of the board at hydrophobic finish application station 82 and the coating cured (set and/or dried) to produce the GFP board 2. The hydrophobic coating is applied as a continuous coating to at least 80% of a surface of the board. FIG. 1 shows the hydrophobic coating 438 applied to one side of the core 424 of the GFP board 2. However, the hydrophobic coating may be applied to both opposed sides (front and back) of the core of the GFP board. In the hydrophobic finish application station 82 the coating may be applied in a single pass or double passes, or multiple passes. Preferably coating is applied in a single pass. Alternative methods of coatings may also be utilized such as screeding, spraying, knife coating or curtain coating.

The dry (cured) hydrophobic coating on the core comprises:
a film forming polymer,
at least one of:
   a non-setting inorganic filler, having a volume mean particle diameter of about 4 microns to about 100 microns, preferably about 6 microns to about 80 microns, more preferably about 8 microns to about 60 microns, most preferably about 10 microns to about 40 microns, and a hydraulic component comprising a fly ash,
wherein, if the hydraulic component is present, the hydrophobic coating further comprises at least one of:
   an extended flow time retention agent comprising at least one member selected from the group consisting of carboxylic acids, salts of carboxylic acids, and mixtures thereof, and
   optionally a silane.

The hydrophobic finish composition used to make the hydrophobic coating when applied to the core comprises an aqueous mixture of:
a film forming polymer,
at least one of:
   a non-setting inorganic filler, having a volume mean particle diameter of about 4 microns to about 100 microns, preferably about 6 microns to about 80 microns, more preferably about 8 microns to about 60 microns, most preferably about 10 microns to about 40 microns, and a hydraulic component comprising a fly ash,
wherein if the hydraulic component is present, the hydrophobic coating further comprises at least one of:
   an extended flow time retention agent comprising at least one member selected from the group consisting of carboxylic acids, salts of carboxylic acids, and mixtures thereof, and optionally a silane.

The hydrophobic coating and hydrophobic finish composition may have an absence of fly ash.

The hydrophobic coating and hydrophobic finish composition may have an absence of pozzolanic material.

The hydrophobic coating and hydrophobic finish composition may have an absence of hydraulic cement.

The hydrophobic coating and hydrophobic finish composition may have an absence of non-setting inorganic filler, having a volume mean particle diameter of about 4 microns to about 100 microns, preferably about 6 microns to about 80 microns, more preferably about 8 microns to about 60 microns, most preferably about 10 microns to about 40 microns.

The hydrophobic coating and hydrophobic finish composition may have an absence of calcium sulfate material.

The hydrophobic coating and hydrophobic finish composition may have an absence of calcium sulfate hemihydrate.

The hydrophobic coating and hydrophobic finish composition may have an absence of calcium sulfate dihydrate.

The hydrophobic coating and hydrophobic finish composition may have an absence of calcium sulfate anhydrite.

The hydrophobic coating may have an absence of extended flow time retention agent.

The hydrophobic coating and the board gypsum core layer may have an absence of silane.

The hydrophobic coating and the board gypsum core layer typically have an absence of alkali metal organosiliconate. The hydrophobic coating and the board gypsum core layer typically have an absence of methylenediphenyldiisocyante.

TABLE 2 lists potential amounts of the ingredients in the wet hydrophobic coating composition that employs a hydraulic component comprising fly ash on a water inclusive (wet) basis. In TABLE 2, a range of a parameter from a column may be used with any range for other parameters from the same or other columns. However, typically in TABLE 2, a range of a parameter from a column is used with the ranges for other parameters from the same column.

TABLE 2
Hydrophobic coating composition that employs a hydraulic
component comprising fly ash (composition by weight % of
the wet finish composition unless otherwise specified)

| | | More | Most |
|---|---|---|---|
| Ingredient | Preferred | Preferred | Preferred |
| Hydraulic component (wt %)* | 50 to | 55 to | 60 to |
| | about 85 | about 75 | about 70% |
| Film-forming polymer (solids | about 5 to | about 7.5 to | about 10 to |
| basis)(wt. %) | about 25 | about 22.5 | about 20 |
| Silane Compound (wt. %) | 5 or less | 0.1-3 | 0-1 |
| Extended flow time retention | 0.05-1.00 | 0.075-0.75 | 0.10-0.50 |
| agent (% by weight | | | |
| of hydraulic component, | | | |
| on dry basis)** | | | |
| One or more optional inorganic | 50 or | 45 or | 40 or |
| fillers and aggregates (wt. %) | less | less | less |
| Optional Water reducing | 0 to | 0% to | 0 to |
| admixture additives (wt. %) | about 5 | about 3 | about 1 |
| Optional colorants (wt. %) | 0 to | 0 to | 0 to |
| | about 2 | about 1.5 | about 1 |
| Water (wt. %) | about 5 to | about 7.5 to | about 10 to |
| | about 30 | about 25 | about 20 |

*% by weight of the wet finish composition, wherein at least half of the hydraulic component by weight is Class C fly ash. The term “wet finish composition” when used in this table and elsewhere in this specification means the composition including water. The term “wet basis” when used in this specification means based on the composition including water.
**Extended flow time retention agent comprising one or more carboxylic acids, one or more salts of carboxylic acids, or mixtures thereof. The term “dry basis” when used in this table and elsewhere in this specification means a water free basis.

TABLE 3 lists potential amounts of the ingredients in the cured coating that employs a hydraulic component comprising fly ash on a dry (water free) basis. Curing encompasses drying and/or setting.

TABLE 3
Cured hydrophobic coating that employs a
hydraulic component comprising fly ash

| | | More | Most |
|---|---|---|---|
| Ingredient | Preferred | Preferred | Preferred |
| Hydraulic component | 55-93 | 65-90 | 75-87 |
| comprising fly ash (wt.) | | | |
| Film-forming polymer | 7-45 | 10-35 | 13-25 |
| (solids basis) (wt.) | | | |
| Silane Compound (wt.) | 0-6 | 0.15-4 | 0.20-2 |
| Extended flow time retention | 0.075-1.5 | 0.10-1.0 | 0.125-0.75 |
| agent comprising one or more | | | |
| carboxylic acids, one or more | | | |
| salts of carboxylic acids, | | | |
| or mixtures thereof (%, by | | | |
| weight of the hydraulic | | | |
| component) | | | |
| One or more optional inorganic | 0-55 | 0-50 | 0-45 |
| fillers and aggregates (wt.) | | | |
| Optional Water reducing | 0-6 | 0-4 | 0-2 |
| admixture additives | | | |
| Optional colorants (wt.) | 0-3 | 0-2 | 0-1 |
| Water (wt.) | 0 | 0 | 0 |

*The term “coating” when used in this specification means the dry composition on the panel core. Thus, it is excluding water.
**The term “dry basis” when used in this specification means a water free basis.

As used in the present specification percent means weight percent unless otherwise indicated.

The hydrophobic finish including the hydraulic component comprising fly ash can be applied at a weight from about 30 lbs./MSF (pounds per thousand square feet) to about 200 lbs./MSF, preferably from about 35 lbs./MSF to about 150 lbs./MSF, more preferably from about 40 lbs./MSF to about 125 lbs./MSF, most preferably 45 lbs./MSF to 100 lbs./MSF.

The hydrophobic finish including the hydraulic component comprising fly ash after drying can have a thickness of about 200 microns to about 300 microns, and preferably 230 microns to 270 microns.

Preferred hydrophobic coatings comprising a hydraulic component comprising fly ash are any of the following:

The hydrophobic coating of U.S. Pat. No. 10,815,149 to Dubey et al., incorporated herein by reference, which discloses a hydrophobic finish composition comprising:
(i) hydraulic component comprising fly ash;
(ii) film-forming polymer;
(iii) at least one silane compound selected from the group consisting of:
(a) silane compounds having a molecular weight of at least about 150,
(b) silane compounds having a general chemical formula (I):

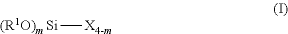

wherein R¹O is an alkoxy group, X is an organofunctional group, and m ranges from 1 to 3, and
(c) mixtures of silane compounds (a) and (b); and
(iv) an extended flow time retention agent comprising at least one member selected from the group consisting of carboxylic acids, salts of carboxylic acids, and mixtures thereof;
wherein said carboxylic acids have the chemical formula (II):

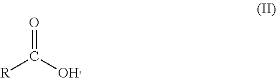

wherein R is an organofunctional group;
wherein the salts of carboxylic acid have the chemical formula (III)

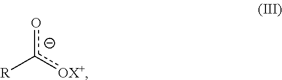

wherein R is as defined in formula (II) and X + is a cation, wherein there is an absence of calcium sulfate.

The hydrophobic coating of U.S. Pat. No. 10,399,898 to Peng et al., incorporated herein by reference, which discloses a hydrophobic finish comprising:
(i) hydraulic component comprising fly ash, the fly ash comprising Class C fly ash in an amount from about 50% to about 85% by weight of the hydrophobic finish composition on a water inclusive basis;
(ii) film-forming polymer in an amount of about 5% to about 25% by weight of the hydrophobic finish composition on a water inclusive basis; and
(iii) an extended flow time retention agent comprising at least one member of the group consisting of carboxylic acids, salts of carboxylic acids, and mixtures thereof,
wherein said carboxylic acids have the chemical formula (II):

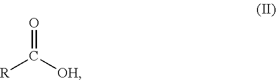

wherein R is an organofunctional group;
wherein the salts of carboxylic acid have the chemical formula (III)

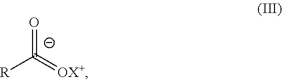

wherein R is as defined in formula (II) and X + is a cation, wherein the extended flow time retention agent is in an amount of 0.05% to 1.00% by weight of the hydrophobic finish composition on a dry basis.

The hydrophobic coating of U.S. Pat. No. 10,336,036 to Dubey et al., incorporated herein by reference, which discloses a wet hydrophobic finish composition comprising:
Class C fly ash, wherein the Class C fly ash is in an amount from about 50% to about 85% by weight of the wet hydrophobic finish composition,
film-forming polymer, wherein the film-forming polymer is in an amount from about 5% to about 25% by weight of the wet hydrophobic finish composition, and
silane compound of the general chemical formula:

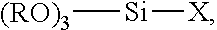

where RO is an alkoxy group and X is an organofunctional group,
wherein the wet hydrophobic finish composition has a pH of at least about 9, and wherein the wet hydrophobic finish composition is substantially free of any other hydraulic material other than the Class C fly ash,
wherein the film-forming polymer is selected from the group consisting of acrylic polymers and copolymers formed from methyl acrylate, methyl methacrylate, ethyl acrylate, ethyl methacrylate, butyl acrylate, butyl methacrylate, propyl acrylate, propyl methylacrylate, 2-ethyl hexyl acrylate and methacrylate, cyclohexyl acrylate and methacrylate, decyl-acrylate and methacrylate, isodecylacrylate and methacrylate, benzyl acrylate and methacrylate, copolymers of styrene and acrylic, copolymers of vinyl acetate and VeoVa (vinyl ester of versatic acid), copolymers of vinyl laurate and ethylene, terpolymers of vinyl acetate, ethylene and methylmethacrylate, terpolymers of vinyl acetate, ethylene and vinyl laurate, terpolymers of vinyl acetate, ethylene and VeoVa (vinyl ester of versatic acid), and any combination thereof,
wherein the board passes the test for waterproofness according to ANSI A118.10 (revised October 2014).

The hydrophobic coating of U.S. Pat. No. 10,155,692 to Dubey et al., incorporated herein by reference, discloses a hydrophobic finish that includes:
fly ash,
film-forming polymer,
at least one silane compound selected from the group consisting of:
   (a) silane compounds having a molecular weight of at least about 150,
   (b) silane compounds having a general chemical formula (I):

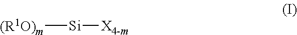

wherein R¹O is an alkoxy group, X is an organofunctional group, and m ranges from 1 to 3, and
   (c) mixtures of silane compounds (a) and (b); and
an extended flow time retention agent comprising at least one member selected from the group consisting of carboxylic acids, salts of carboxylic acids, and mixtures thereof;
wherein said carboxylic acids have the chemical formula (II):

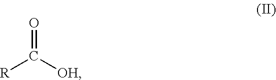

wherein R is an organofunctional group;
wherein the salts of carboxylic acid have the chemical formula (III)

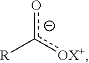

wherein R is as defined in formula (II) and X + is a cation.

A preferred hydrophobic finish composition without a hydraulic component is disclosed by U.S. Pat. No. 11,225,793 to Peng et al., incorporated herein by reference, which discloses a non-setting, hydrophobic finish composition including:
(i) about 50 to about 80 weight % non-setting, inorganic filler having a volume mean particle diameter of about 12 microns to about 35 microns, preferably about 13 microns to about 25 microns,
(ii) about 20% to about 50 weight % an aqueous dispersion of a film-forming polymer,
(iii) 0% to about 30 weight % additional water;
(iv) an absence of fly ash,
(v) an absence of pozzolanic material,
(vi) an absence of hydraulic cement,
(vii) an absence of calcium sulfate hemihydrate, and
(viii) an absence of calcium sulfate anhydrite.

The non-setting, hydrophobic finish comprises, consists essentially of, or consists of: (1) a non-setting, inorganic filler having a volume mean particle diameter of about 4 microns to about 100 microns, preferably about 6 microns to about 80 microns, more preferably about 8 microns to about 60 microns, most preferably about 10 microns to about 40 microns, (2) an aqueous dispersion of film-forming polymer, and (3) optionally additional water and/or additives. Preferably, the non-setting, inorganic filler is in an amount from about 50% to about 80% by weight of the finish composition on a water inclusive basis. Preferably, the aqueous dispersion of film-forming polymer has about 20 to about 60% solids, more preferably about 40 to about 55% solids, typically about 40 to 50% solids. Preferably, the aqueous dispersion of film-forming polymer is in an amount from about 20% to about 50% by weight of the finish composition on a water inclusive basis.

The non-setting, hydrophobic finish can be used as a coating in cement board or gypsum board products, for example, for tile backerboard.

TABLE 4 provides the composition of various non-setting, hydrophobic finish formulations of the present invention. In TABLE 4, a range of a parameter from a column may be used with any range for other parameters from the same or other columns. However, typically in TABLE 4, a range of a parameter from a column is used with the ranges for other parameters from the same column. The coating (hydrophobic finish composition) formulation wt. % on a wet (water included) basis typically has about 5 to about 35%, preferably about 5 to about 30%, by weight water.

TABLE 4
Coating (hydrophobic finish composition) formulation
wt. % on a wet (water included) basis

| | Useable | Preferred | Most Preferred | Specific |
|---|---|---|---|---|
| Ingredient | range | range | Range | example |
| Non-setting, inorganic | 50-80 | 55-75 | 60-70 | 66 |
| filler * | | | | |
| Aqueous dispersion of | 20-50 | 20-45 | 25-40 | 32 |
| film-forming polymer ** | | | | |
| Additional Water | 0-30 | 0-20 | 0-10 | 2 |
| Fly ash | 0 | 0 | 0 | 0 |
| Pozzolanic material | 0 | 0 | 0 | 0 |
| Hydraulic cement | 0 | 0 | 0 | 0 |
| Calcium sulfate | 0 | 0 | 0 | 0 |
| hemihydrate | | | | |
| Calcium sulfate | 0 | 0 | 0 | 0 |
| anhydrite | | | | |
| Optional Additives | 0-10 | 0-5 | 0-2 | 0 |

* filler having volume mean particle diameter of about 4 microns to about 100 microns, preferably about 6 microns to about 80 microns, more preferably about 8 microns to about 60 microns, most preferably about 10 microns to about 40 microns
** The aqueous dispersion of film-forming polymer comprises water and the film-forming polymer with about 20 wt. % to about 60 wt. % solids, preferably about 40 wt. % to about 60 wt. % solids, typically about 40 wt. % to about 50 wt. % solids

TABLE 5 lists potential amounts of the ingredients in the dry coating that employs a hydraulic component comprising fly ash

TABLE 5
Coating (hydrophobic finish composition) formulation
wt % on a dry (water free) basis

| | Useable | Preferred | Most Preferred | Specific |
|---|---|---|---|---|
| | range | range | Range | example |
| Non-setting, | 55-92 | 65-88 | 75-83 | 80 |
| inorganic filler* | | | | |
| Film-forming | 4-30 | 10-28 | 13-25 | 20 |
| polymer solids | | | | |
| Additional Water | 0 | 0 | 0 | 0 |
| Fly ash | 0 | 0 | 0 | 0 |
| Pozzolanic material | 0 | 0 | 0 | 0 |
| Hydraulic cement | 0 | 0 | 0 | 0 |
| Calcium sulfate | 0 | 0 | 0 | 0 |
| hemihydrate | | | | |
| Calcium sulfate | 0 | 0 | 0 | 0 |
| anhydrite | | | | |
| Optional Additives | 0-20 | 0-15 | 0-10 | 0 |

*volume mean particle diameter of about 4 to about 100 microns, preferably about 6 to about 80 microns, more preferably about 8 to about 60 microns, most preferably about 10 to about 40 microns.

The non-setting, hydrophobic finish can be applied in an amount of 30 to 200 lbs./msf, preferably 35 to 150 lbs./msf, more preferably 40 to 125 lbs/msf, most preferably 45 to 100 lbs/msf. This is weight of the hydrophobic finish composition as applied wet.

The non-setting, hydrophobic finish after drying can have a thickness of about 200 microns to about 300 microns, and preferably 230 microns to 270 microns.

### Film-Forming Polymer

The hydrophobic coating compositions, with and without a hydraulic component comprising fly ash, employ a film forming polymer.

The hydrophobic coating compositions of the invention on a water inclusive basis typically have about 20 wt. % to about 50 wt. % of an aqueous dispersion of the film forming polymer.

The aqueous dispersion of film-forming polymer comprises water and the film-forming polymer with about 20 wt. % to about 60 wt. % solids, preferably about 40 wt. % to about 60 wt. % solids, typically about 40 wt. % to about 50 wt. % solids.

The film-forming polymer of the hydrophobic finish of the present invention is preferably made from a pure acrylic, a rubber, a styrene butadiene rubber, a styrene acrylic, a vinyl acrylic, or an acrylated ethylene vinyl acetate copolymer. Preferably film-forming polymer is derived from at least one acrylic monomer selected from the group consisting of acrylic acid, acrylic acid esters, methacrylic acid, and methacrylic acid esters. For example, the monomers preferably employed in emulsion polymerization include methyl acrylate, methyl methacrylate, ethyl acrylate, ethyl methacrylate, butyl acrylate, butyl methacrylate, propyl acrylate, propyl methylacrylate, 2-ethyl hexyl acrylate and methacrylate, cyclohexyl acrylate and methacrylate, decyl-acrylate and methacrylate, isodecylacrylate and methacrylate, benzyl acrylate and methacrylate, other acrylates, methacrylates and their blends, acrylic acid, methacrylic acid, styrene, vinyl toluene, vinyl acetate, vinyl esters of higher carboxylic acids than acetic acid, for example, vinyl versatate, acrylonitrile, acrylamide, butadiene, ethylene, vinyl chloride and the like, and mixtures thereof.

Typically, the film-forming polymer is water-soluble such as, for example, a latex polymer. The polymer can be used in either liquid form or as a re-dispersible polymer. One example a styrenated acrylic copolymer.

Preferably, the film-forming polymer comprises one or more of the following: acrylic polymers and copolymers, rubber-based polymers and copolymers such as styrene-butadiene rubber, copolymers of styrene and acrylic, copolymers of vinyl acetate and ethylene, copolymers of vinyl chloride and ethylene, copolymers of vinyl acetate and vinyl ester of versatic acid, copolymers of vinyl laurate and ethylene, terpolymers of vinyl acetate, ethylene and methyl methacrylate, terpolymers of vinyl acetate, ethylene and vinyl laurate, terpolymers of vinyl acetate, ethylene, and vinyl esters of branched tertiary monocarboxylic acids (e.g. vinyl ester of versatic acid or neo vinyl esters, of itaconic acid, crotonic acid, maleic acid, fumaric acid), and any combination thereof.

As used herein, “molecular weight” in reference to a polymer or any portion thereof, means to the weight-average molecular weight (“Mw”) of the polymer or portion. In one embodiment, the polymers for use in the present invention exhibit a weight average molecular weight of greater than or equal to 10,000 grams per mole (“g/mole”). For example, in a range of 30,000 to 5,000,000 g/mole. More typically the polymer of the present invention exhibits a weight average molecular weight of from about 100,000 g/mole to about 2,500,000 g/mole, or more typically about 150,000 g/mole to about 1,000,000 g/mole.

Commonly used monomers are butyl acrylate, methyl methacrylate, ethyl acrylate and the like. Preferably, the monomers include one or more monomers selected from the group consisting of n-butyl acrylate, methyl methacrylate, styrene, and 2-ethylhexyl acrylate.

The film-forming polymer is preferably derived from at least one acrylic monomer selected from the group consisting of acrylic acid, acrylic acid esters, methacrylic acid, and methacrylic acid esters. For example, the film-forming polymer can be a butyl acrylate/methyl methacrylate copolymer or a 2-ethylhexyl acrylate/methyl methacrylate copolymer. For example, the film-forming polymer can be a butyl acrylate/methyl methacrylate copolymer or a 2-ethylhexyl acrylate/methyl methacrylate copolymer.

Typically, the film-forming polymer is further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C4-C8 conjugated dienes such as 1,3-butadiene, isoprene or chloroprene. For example, the film-forming polymer can be a pure acrylic, a styrene acrylic, a vinyl acrylic, or an acrylated ethylene vinyl acetate copolymer.

The pure acrylics preferably comprise acrylic acid, methacrylic acid, an acrylate ester, and/or a methacrylate ester as the main monomers. The styrene acrylics preferably comprise styrene and acrylic acid, methacrylic acid, an acrylate ester, and/or a methacrylate ester as the main monomers. The vinyl acrylics preferably comprise vinyl acetate and acrylic acid, methacrylic acid, an acrylate ester, and/or a methacrylate ester as the main monomers. The acrylated ethylene vinyl acetate copolymers preferably comprise ethylene, vinyl acetate and acrylic acid, methacrylic acid, an acrylate ester, and/or a methacrylate ester as the main monomers. The monomers can also include other main monomers such as acrylamide and acrylonitrile, and one or more functional monomers such as itaconic acid and ureido methacrylate, as would be readily understood by those skilled in the art. In a particularly preferred embodiment, the film-forming polymer is a pure acrylic such as a butyl acrylate/methyl methacrylate copolymer derived from monomers including butyl acrylate and methyl methacrylate.

A typical film-forming polymer is comprised of one or more esters of acrylic or methacrylic acid, typically a mixture, for example, about 50/50 by weight, of a high Tg monomer (e.g. methyl methacrylate) and a low Tg monomer (e.g. butyl acrylate), with small proportions (e.g. about 0.5% to about 2% by weight) of acrylic or methacrylic acid. The vinyl-acrylic polymers for example include vinyl acetate and butyl acrylate and/or 2-ethyl hexyl acrylate and/or vinyl versatate. In a typical vinyl-acrylic polymer, at least 50% of the polymer formed is comprised of vinyl acetate, with the remainder being selected from the esters of acrylic or methacrylic acid. The styrene/acrylic polymers are typically similar to the acrylic polymers, with styrene substituted for all or a portion of the methacrylate monomer thereof.

Combinations of the foregoing polymers are suitable for use as the film-forming polymer.

The aqueous dispersion of film-forming polymer can be included in the hydrophobic finish of the present invention in an amount (on a wet basis of the total hydrophobic finish) of about 20 wt % to about 50 wt %, preferably about 25 wt % to about 45 wt %, more preferably about 30 wt % to about 40 wt %, for example 33 wt %.

### Additional Water

Water, in addition to the water from other components (e.g., aqueous dispersion of film-forming polymer) of the hydrophobic finish, can be included in the hydrophobic finish of the present invention in an amount (on a wet basis of the total hydrophobic finish, when included) of about 0.01 wt % to about 30 wt %, preferably about 0.1 wt % to about 20 wt %, and more preferably about 0.1 wt % to about 10 wt %. In some embodiments, the hydrophobic finish (before application as a coating) can have an absence of additional water.

### Non-Setting, Inorganic Filler

The non-setting, inorganic filler having a volume mean particle diameter of about 4 microns to about 100 microns, preferably about 6 microns to about 80 microns, more preferably about 8 microns to about 60 microns, most preferably about 10 microns to about 40 microns, if present, is typically in the hydrophobic finish composition in an amount (on a wet (water inclusive) basis of the total hydrophobic finish) of about 50 wt. % to about 80 wt. %, preferably about 55 wt. % to about 75 wt. %, more preferably about 50 wt. % to about 70 wt. %, for example 67 wt. %.

Examples of non-setting, inorganic fillers include, but are not limited to, calcium carbonate, sand, mica, glass microspheres, non-pozzolanic perlite, coated perlite, talcs, hydrated alumina, and any combination thereof. Preferably the non-setting, inorganic filler comprises 50 wt. % or more calcium carbonate by weight of the non-setting, inorganic filler, more preferably 75 wt. % or more calcium carbonate by weight of the non-setting, inorganic filler, and most preferably 90 wt. % or more calcium carbonate by weight of the non-setting, inorganic filler, including 100 wt % calcium carbonate by weight of the non-setting, inorganic filler.

Perlite is generally a non-setting, inorganic material. However, if ground finely, perlite can have pozzolanic properties. As used herein, the term “non-pozzolanic perlite” refers to perlite that does not have pozzolanic properties as defined in ASTM C618-97. The hydrophobic finish of the present invention has an absence of pozzolanic perlite. Optionally, the hydrophobic finish of the present invention can have an absence of non-pozzolanic perlite.

Ground limestone can be a suitable calcium carbonate suitable for use in the hydrophobic finish of the present invention. An exemplary commercially available calcium carbonate suitable for use in the hydrophobic finish of the present invention includes, but is not limited to, a calcium carbonate from the OMYACARB® product line (available from Omay AG), a calcium carbonate from the HUBERCRETE® product line (e.g., HUBERCRETE® M PRIME) (available from Huber Engineered Materials), and combinations thereof.

The non-setting, inorganic filler preferably comprises particles that are sized to mitigate settling (i.e., not too large) and to mitigate high viscosity (i.e., not too small). While the concentration of additives like dispersants and the composition of the non-setting, inorganic filler affect the particle settling and dispersion viscosity, preferably, the non-setting, inorganic filler can comprise particles having a volume mean particle diameter of about 4 microns to about 100 microns, preferably about 6 microns to about 80 microns, more preferably about 8 microns to about 60 microns, most preferably about 10 microns to about 40 microns. For purposes of the present disclosure, for irregular shaped particles, the size or diameter is its largest dimension.

The non-setting hydrophobic finish of the present invention has an absence of fly ash and an absence of other pozzolanic material. Thus, the hydrophobic finish of the invention has an absence of pozzolanic perlite. However, perlite if rendered non-pozzolanic may be included in the hydrophobic finish of the invention. However, the hydrophobic finish of the present invention may have an absence of all perlite.

Ground granulated blast furnace slag can act as a pozzolanic material, a hydraulic cement, or both. Regardless of whether ground granulated blast furnace slag acts as a pozzolanic material, a hydraulic cement, or both, the non-setting hydrophobic finish of the present invention has an absence of blast furnace slag.

If the hydrophobic finish of the invention is employed with the non-setting, inorganic filler and no hydraulic component then the hydrophobic finish of the present invention is a drying type and not a setting type. Thus, for setting type hydrophobic finish retarding agents are not necessarily needed. Typically the setting type hydrophobic finish of the present invention has an absence of a retarding agent. The setting type hydrophobic finish of the present invention preferably has an absence of a retarding agent comprising at least one member of the group consisting of carboxylic acids (e.g., citric acid and gluconic acid), salts of carboxylic acids (e.g., sodium citrate and sodium gluconate), and mixtures thereof.

### Hydraulic Component Comprising Fly Ash

As used herein, the term “hydraulic component” also known as “hydraulic setting composition” refers to a composition that when contacted with water initiates a hydration reaction and hardens. Examples of hydraulic setting compositions include, but not limited to, fly ash, pozzolanic material, hydraulic cement, calcium sulfate hemihydrate, and calcium sulfate anhydrite.

The hydraulic component, if present, comprises, consists essentially of, or consists of fly ash. The fly ash, if present, in the hydrophobic coating and hydrophobic finish composition is preferably Class C fly ash. The hydraulic component, if present, is typically in the hydrophobic finish composition in an amount from about 50% to about 85% by weight of the hydrophobic finish composition on a water inclusive basis.

The finish composition includes hydraulic component comprising fly ash, preferably the fly ash comprises Class C fly ash, wherein the fly ash more preferably comprises Class C fly ash in an amount from about 50 wt. % to about 85 wt. % by weight of the finish composition on a water inclusive basis. In general the finish composition hydraulic component comprises Class C fly ash or an equivalent fly ash. For purposes of the present invention a Class C fly ash is defined as a fly ash containing a lime content of at least 10% by weight of the fly ash and a fly ash is considered equivalent to Class C fly ash if it contains sufficiently high lime (CaO) content, wherein sufficient lime is at least about 10 wt. %. Preferably the Class C fly ash or the equivalent fly ash has a lime content of greater than about 20 wt. %, and more preferably greater than 25 wt. % of the total weight of fly ash, and most preferably about 25 to 45 wt. % of the total weight of fly ash. ASTM C-618 describes the characteristics of Class C fly ash (e.g., Bayou Ash Inc., Big Cajun, II, LA or Boral Material Technologies, Scherer Plant—Juliette, GA). The Class C fly ash can have lime content as high as about 45%.

When mixed with water, the fly ash sets similarly to a cement or gypsum. In some embodiments, the finish composition comprises Class C fly ash and is substantially free of any other hydraulic material. As used herein, “substantially free” of such other hydraulic material means that the composition contains 0 wt. % based on the weight of the composition, or no such other hydraulic material, or an ineffective or immaterial amount of such other hydraulic material. An example of an ineffective or immaterial amount may be, e.g., about 10% or less, about 5% or less, about 2% or less, about 1% or less, about 0.5% or less, or about 0.1% or less, based on the weight of the composition. As mentioned in above, at least half of the hydraulic component by weight is Class C fly ash.

TABLE 6 shows the oxide composition (XRF analysis) of the Class C fly ash used in the examples of this invention. This fly ash is from the Scherer Power Plant, Juliette, Georgia and is supplied by Boral Material Technologies, Inc.

TABLE 6

| Oxide | Wt % |
|---|---|
| CaO | 27.36 |
| SO₃ | 2.08 |
| MgO | 5.70 |
| Na₂O | 1.47 |
| Al₂O₃ | 18.18 |
| Fe₂O₃ | 5.64 |
| SiO₂ | 33.24 |
| P₂O₅ | 1.54 |
| K₂O | 0.36 |
| TiO₂ | 1.33 |
| Loss on Ignition | 0.17 |
| (LOI) (110-750° C.) | |

However, in other embodiments, use of other hydraulic components in combination with fly ash are contemplated, including cements, including high alumina cements, calcium sulfates, including calcium sulfate anhydrite, calcium sulfate hemihydrates or calcium sulfate dihydrate, other hydraulic components and combinations thereof. Mixtures of fly ashes are also contemplated for use, for example, mixtures of Class C fly ash and Class F fly ash having at least 85 wt. % Class C fly ash. Silica fume (e.g., SKW Silicium Becancour, St. Laurent, Quebec, Canada) is another preferred material.

Silica fume may be used in combination with fly ash. Silica fume, also known as microsilica, (CAS number 69012-64-2, EINECS number 273-761-1) is an amorphous (non-crystalline) polymorph of silicon dioxide, silica. It is an ultrafine powder collected as a by-product of the silicon and ferrosilicon alloy production and consists of spherical particles with an average particle diameter of 150 nm. The main field of application is as pozzolanic material for high performance concrete. It is sometimes confused with fumed silica (also known as pyrogenic silica, CAS number 112945-52-5). However, the production process, particle characteristics and fields of application of fumed silica are all different from those of silica fume.

When Portland cement, quick lime (CaO) or hydrated lime (Ca(OH)2) are included in the hydraulic component, they may produce heat and impact rheology such that the finish composition may be adversely affected such as in the form of cracking or other damage. Accordingly, in some embodiments, Portland cement is included in the hydraulic component in an amount of about 50% or less by weight of the hydraulic component, such as about 45% or less, about 40% or less, about 35% or less, about 30% or less, about 25% or less, about 20% or less, about 15% or less, about 10% or less, about 5% or less, about 1% or less, or about 0.1% or less. In the case of quick lime, if included, in some embodiments, it is included in an amount of about 10% or less by weight of the hydraulic component, such as about 8% or less, about 5% or less, about 3% or less, about 1% or less, about 0.5% or less, or about 0.1% or less. With respect to hydrated lime, if included, in some embodiments, it is included in an amount of about 25% or less by weight of the hydraulic component, such as about 20% or less, about 15% or less, about 10% or less, about 5% or less, about 1% or less, about 0.5% or less, or about 0.1% or less.

Another reason Class C fly ash is desired is the increased life cycle expectancy and increase in durability associated with its use. During the hydration process, fly ash chemically reacts with the calcium hydroxide forming calcium silicate hydrates and calcium aluminate hydrates, which reduces the risk of leaching calcium hydroxide, making the composition less permeable. Class C fly ash also improves the permeability of hydraulic compositions by lowering the water-to-cement ratio, which reduces the volume of capillary pores remaining in the set composition. The spherical shape of fly ash improves the consolidation of the composition, which also reduces permeability. It is also theorized tricalcium aluminate, frequently present in fly ash, acts as a set accelerator to speed up the setting reactions. Calcium aluminate is usually found in fly ash, and it can lead to fast setting action. The present invention typically provides the benefit of including the extended flow control agent to facilitate industrial continuous production in spite of the presence of fast setting materials such as calcium aluminates in the hydraulic component.

In some embodiments, the fly ash has volume mean particle size (diameter) from about 1 micron to about 100 microns. In embodiments of the invention, the volume mean particle size of the fly ash can be, for example, as listed in TABLE 7 below. In the table, an “X” represents the range “from about [corresponding value in first row] to about [corresponding value in first column].” The indicated values represent volume mean particle size in microns. For ease of presentation, it will be understood each value represents “about” that value. For example, the first “X” is the range “from about 1 micron to about 10 microns.”

TABLE 7
volume mean particle size of fly ash (microns)

| | 1 | 10 | 20 | 30 | 40 | 50 | 60 | 70 | 80 | 90 |
|---|---|---|---|---|---|---|---|---|---|---|
| 10 | X | | | | | | | | | |
| 20 | X | X | | | | | | | | |
| 30 | X | X | X | | | | | | | |
| 40 | X | X | X | X | | | | | | |
| 50 | X | X | X | X | X | | | | | |
| 60 | X | X | X | X | X | X | | | | |
| 70 | X | X | X | X | X | X | X | | | |
| 80 | X | X | X | X | X | X | X | X | | |
| 90 | X | X | X | X | X | X | X | X | X | |
| 100 | X | X | X | X | X | X | X | X | X | X |

Thus, the volume mean particle size (also known as volume mean particle diameter) can have a range between and including any of the aforementioned endpoints.

In some embodiments, the hydraulic component is substantially free of silica (SiO₂), alumina (Al₂O₃) or iron oxide (Fe₂O₃). As used herein, “substantially free” of silica, alumina or iron oxide means that the composition contains 0 wt. % based on the weight of the composition, or no silica, alumina or iron oxide, or an ineffective or immaterial amount of silica, alumina or iron oxide. An example of an ineffective amount is an amount below the threshold amount to achieve the intended purpose of using such setting material, as one of ordinary skill in the art will appreciate. An immaterial amount may be, e.g., about 5% or less, about 2% or less, about 1% or less, or about 0.1% or less, based on the weight of the composition, depending on the ingredient, as one of ordinary skill in the art will appreciate.

However, if desired in some embodiments, silica, alumina, and/or iron oxide can be included. If included, in some embodiments, these materials in total account for less than about 50% by weight of the hydraulic component, such as for example, less than about 40%, less than about 30%, less than about 20%, or less than about 10% by weight of the hydraulic component.

The amount of the hydraulic component (e.g., Class C fly ash alone or in combination with other hydraulic material) in some embodiments can be from about 50% to about 85% by weight of the wet finish composition. In embodiments of the invention, the amount of the hydraulic component can be, for example, as listed in TABLE 8 below. In the table, an “X” represents the range “from about [corresponding value in first row] to about [corresponding value in first column].” The indicated values represent percentage by weight of the wet finish composition. For ease of presentation, it will be understood each value represents “about” that value. For example, the first “X” is the range “from about 50% by weight of the wet finish composition to about 55% by weight of the composition.” Wet finish composition means the total composition including water before the water evaporation (the water can come from various sources, for example a latex emulsion of polymer when added may be 50% water and 50% polymer solids). Thus, the amount of the hydraulic component, preferably Class C fly ash, can have a range between and including any of the aforementioned endpoints as listed in TABLE 8.

TABLE 8
(wt. %)

| | 50 | 55 | 60 | 65 | 70 | 75 | 80 |
|---|---|---|---|---|---|---|---|
| 55 | X | | | | | | |
| 60 | X | X | | | | | |
| 65 | X | X | X | | | | |
| 70 | X | X | X | X | | | |
| 75 | X | X | X | X | X | | |
| 80 | X | X | X | X | X | X | |
| 85 | X | X | X | X | X | X | X |

Preferably, the hydraulic component comprising Class C fly ash is in an amount from about 50% to about 85% by weight of the wet finish.

Hydraulic cements for purposes of this invention is a cement that undergoes a chemical setting reaction when it comes in contact with water (hydration) and which will not only set (cure) under water but also forms a water-resistant product. Hydraulic cements include, but are not limited to, aluminum silicate cements like Portland cement, calcium sulfoaluminate cement, calcium aluminate-based cement, and calcium fluoroaluminate cements. The hydrophobic finish of the present invention has an absence of hydraulic cement.

As used herein, “Portland cement” is a calcium silicate based hydraulic cement. ASTM C 150 defines Portland cement as “hydraulic cement (cement that not only hardens by reacting with water but also forms a water-resistant product) produced by pulverizing clinkers consisting essentially of hydraulic calcium silicates, usually containing one or more of the forms of calcium sulfate as an inter ground addition.” As used herein, “clinkers” are nodules (diameters, about 0.2 to about 1.0 inch [5-25 mm]) of a sintered material that are produced when a raw mixture of predetermined composition is heated to high temperature. The hydrophobic finish of the present invention has an absence of Portland cement.

ASTM C618-97 defines pozzolanic materials as “siliceous or siliceous and aluminous materials which in themselves possess little or no cementitious value, but will, in finely divided form and in the presence of moisture, chemically react with calcium hydroxide at ordinary temperatures to form compounds possessing cementitious properties.” Pozzolanic materials include, but are not limited to, pozzolanic perlite, pumice, diatomaceous earth, montmorillonite clay, silica fume, tuff, trass, rice husk, metakaolin, shale, ground granulated blast furnace slag, fly ash, and any natural pozzolan like volcanic ash. The hydrophobic finish of the present invention may have an absence of pozzolanic materials.

If there is an absence of pozzolanic materials from the hydrophobic finish of the present invention, the hydrophobic finish of the invention has an absence of pozzolanic perlite. However, perlite if rendered non-pozzolanic may be included in the hydrophobic finish of the invention. However, the hydrophobic finish of the present invention may have an absence of all perlite.

Ground granulated blast furnace slag can act as a pozzolanic material, a hydraulic cement, or both. Regardless of whether ground granulated blast furnace slag acts as a pozzolanic material, a hydraulic cement, or both, the hydrophobic finish of the present invention may have an absence of blast furnace slag.

### Extended Flow Time Retention Agent

The extended flow time retention agent, if present, comprising at least one member selected from the group consisting of carboxylic acids, salts of carboxylic acids, and mixtures thereof, if present, is typically in the hydrophobic finish composition in an amount from about 0.05% to about 1.0%, more typically about 0.075% to about 0.75%, by weight of the hydraulic component.

The hydrophobic finish composition of the invention (also known as a coating composition) comprises an extended flow time retention agent comprising, consisting, or consisting essentially of at least one member of the group consisting of carboxylic acids, salts of carboxylic acids, or mixtures thereof. Preferably the salts are alkali (for example sodium or potassium), alkaline (for example calcium), or ammonium salts, most preferably the salts are sodium or potassium salts. The hydrophobic finish (coating) compositions of the invention comprising an extended flow time retention agent stay fluid and workable for at least 30 minutes or longer, preferably at least 60 minutes or longer, more preferably at least 120 minutes or longer, and most preferably at least 240 minutes or longer without stiffening.

Typically carboxylic acid has the chemical formula (II):

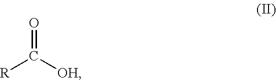

wherein R is an organofunctional group, the organic moiety may be substituted or unsubstituted, for example it may be substituted with one or more additional carboxyl functional groups (—COOH);
wherein the salts of carboxylic acid have the chemical formula (III)

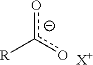

wherein R is as defined in formula (II) and X⁺ is a cation, for example sodium or potassium.

The term organofunctional group in the present specification means a substituted or unsubstituted organic moiety.

Various carboxylic acid families particularly useful as extended flow time retention agent in the compositions of this invention include tricarboxylic acids such as citric acid and isocitric acid; dicarboxylic acids such as malic acid, succinic acid and aldaric acids; sugar acids such as aldonic acids, uronic acids and aldaric acids; aromatic carboxylic acids such as benzoic acid and salicylic acid; aromatic alpha hydroxy acid such as mandelic acid; amino carboxylic acids such as ethylene diamine tetra acetic acid (EDTA), ethylene glycol tetra acetic acid (EGTA), diethylene triamine penta acetic acid (DTPA) and ethylene diamine disuccinic acid (EDDS); alpha hydroxy acids such as tartaric acid; beta hydroxy acids such as salicylic acid. Typical aldonic acids are gluconic acid, glyceric acid, and xylonic acid. Typical aldaric acids are tartaric acid, mucic acid, and saccharic acid. Typical uronic acids are glucuronic acid, galacturonic acid. These carboxylic acid families, and alkali, alkaline, and ammonium salts thereof, most preferably sodium salts thereof and potassium salts thereof, are particularly useful in the present invention.

A tricarboxylic acid is an organic carboxylic acid whose chemical structure contains three carboxyl functional groups (—COOH). The general molecular formula for dicarboxylic acids can be written as R—(CO₂H)₃, where R can be aliphatic or aromatic, preferably C3-C6 aliphatic, most preferably C3 aliphatic.

A dicarboxylic acid is an organic carboxylic acid whose chemical structure contains two carboxyl functional groups (—COOH). The general molecular formula for dicarboxylic acids can be written as HO₂C—R—CO₂H, where R can be a bond, aliphatic, or aromatic, preferably C1-C15 aliphatic.

Sugar acids are monosaccharides with a carboxyl functional groups (—COOH). Preferred classes of sugar acids include Aldonic acids, Uronic acids, or Aldaric acids.

Aldonic acids are any of a family of sugar acids obtained by oxidation of the aldehyde functional group of an aldose to form a carboxylic acid functional group. Typical aldonic acids are glyceric acid, xylonic acid, gluconic acid, and ascorbic acid. Structural formula (IIa) shows the chemical structure of D-gluconic acid, an aldonic acid derived from glucose:

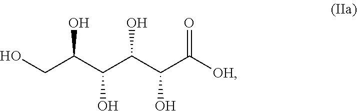 [SMILES: O=C(O)[C@H](O)[C@@H](O)[C@H](O)[C@H](O)CO]

Uronic acids are any of a family of sugar acids in which the terminal hydroxyl group of an aldose or ketose is oxidized. The Uronic acids have both carbonyl and carboxylic acid functional groups. They are sugars in which the terminal carbon's hydroxyl group has been oxidized to a carboxylic acid. Typical Uronic acids are Glucuronic acid, Galactouronic acid, and Iduronic acid. Structural formula (IIb) shows the chemical structure of beta-D glucuronic acid:

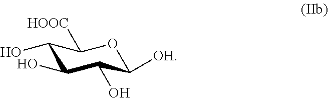

Aldaric acids are any of a family of sugar acids in which both ends of an aldose are oxidized. An aldaric acid is an aldose in which both the hydroxyl function of the terminal carbon and the aldehyde function of the first carbon have been fully oxidized to carboxylic acid functions. (Oxidation of just the aldehyde yields an aldonic acid while oxidation of just the terminal hydroxyl group yields an uronic acid.) Typical Aldaric acids are Tartaric acid, meso-Galactaric acid, and D-Glucaric acid. Structural formula (IIc) shows the chemical formula of glucaric acid, also known as saccharic acid:

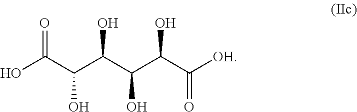 [SMILES: O=C(O)[C@@H](O)[C@@H](O)[C@H](O)[C@@H](O)C(=O)O]

Aromatic carboxylic acids include compounds that contain a carboxyl functional groups (—COOH) bonded to an aromatic ring.

Amino carboxylic acids have both the amine and the carboxylic acid groups. Typical amino carboxylic acids have both the amine and the carboxylic acid groups attached to the first (alpha-) carbon atom. They are known as 2-, alpha-, or α-amino acids (generic formula H₂NCHRCOOH, wherein R is a substituted or unsubstituted organic moiety). Amino carboxylic acids can have multiple amino and/or multiple carboxylic acid groups.

α-Hydroxy acids, or alpha hydroxy acids (AHAs), are a class of chemical compounds that contains a carboxylic acid substituted with a hydroxyl group on the adjacent carbon. Tartaric acid and citric acid are examples of alpha hydroxy acid. Glyceric acid, glycolic acid, and lactic acid are also examples of alpha hydroxy acids. An alpha hydroxy acid contains a carboxylic acid functional group and hydroxy functional group separated by one carbon atom. In contrast, a beta hydroxy acid or β-hydroxy acid (BHA) is an organic compound that contains a carboxylic acid functional group and hydroxy functional group separated by two carbon atoms. Salicyclic acid is an example of beta hydroxy acid.

Preferably the extended flow time retention agents of the present invention are carboxylic acids selected from at least member of the group consisting of dicarboxylic acids, tricarboxylic acids, alpha hydroxy acids, and sugar acids, and alkali, alkaline, or ammonium salts thereof. Preferably the carboxylic acid salts of the present invention are sodium or potassium salts.

Preferably for the finish compositions, articles, and mat faced cementitious boards of the present invention the extended flow time retention agent comprises at least one member of the group consisting of tartaric acid, gluconic acid, citric acid, sodium gluconate, potassium gluconate, potassium tartrate, sodium tartrate, potassium sodium tartrate, sodium citrate, and potassium citrate. Preferred forms of potassium tartrate useful in this invention are also variously known as L(+)-potassium L-tartrate monobasic, tartaric acid monopotassium salt, potassium hydrogen L-tartrate, potassium hydrogen tartrate.

Examples of preferred carboxylic acid based flow time retention agents of this invention include citric acid, tartaric acid, and gluconic acid. Examples of more preferred flow time retention agents include gluconic acid and tartaric acid. Tartaric acid is one of the most preferred flow time retention agents. Different forms of tartaric acids can be employed in the present invention including levotartaric acid, dextrotartaric acid, racemic acid and mesotartaric acid.

Examples of preferred flow time retention agents that are salts of carboxylic acids include sodium citrate, potassium citrate, sodium gluconate, potassium gluconate, potassium tartrate, sodium tartrate, potassium sodium tartrate. Sodium gluconate, potassium gluconate, potassium tartrate, sodium tartrate, potassium sodium tartrate represent some of the more preferred flow time retention agents of this invention. Potassium tartrate is one of the most preferred flow time retention agents of this invention; however, as described previously, tartaric acid is more preferred than potassium tartrate in the present invention.

According to this invention, the flow time retention agents based on carboxylic acids are superior to their counterparts based on salts of the same carboxylic acid, particularly sodium and potassium salts. For instance, according to this invention, tartaric acid has been found to be superior to potassium tartrate or sodium tartrate; alternatively, gluconic acid has been found to be superior to sodium gluconate or potassium gluconate. Surprisingly it has also been discovered that the coating compositions of this invention comprising carboxylic acid based flow time retention agents provide significantly reduced surface water absorption than the corresponding compositions comprising salts of the same carboxylic acid. This is an important discovery since a main use of the hydrophobic coatings of the present invention is for waterproofing applications.

Present invention compositions may comprise carboxylic acid flow retention agents separately from the salts of carboxylic acid flow retention agent as shown, for example, in some present specification examples. In the alternative, present invention compositions may comprise carboxylic acid extended flow retention agents together with the salts of carboxylic acid extended flow retention agent as shown, for example, in other present specification examples.

Thus, the hydrophobic finish compositions of the invention can also use mixtures of carboxylic acids and salts of carboxylic acids as flow time retention agent. For instance, tartaric acid may be used in combination with potassium tartrate; or, tartaric acid may be used in combination with sodium gluconate; or gluconic acid may be used in combination with potassium tartrate; etc.

The carboxylic acid and/or carboxylate salt based flow time retention agent can be present in accordance with embodiments of the invention in an amount from about 0.05% to about 1.00% by weight based upon weight of the hydraulic component on a water free (dry) basis. Thus, for example if there are 100 grams of hydraulic component solids with no water and the carboxylic acid is 0.5% by weight based upon weight of the hydraulic component, then there are 0.5 grams of carboxylic acid and the total weight of the hydraulic component solids and the flow time retention agent is 100.5 grams. Likewise for example, if there are 100 grams of hydraulic component and the carboxylic acid is 0.50 wt % and the salt of carboxylic acid is 0.25 wt %, respectively, by weight based upon weight of the hydraulic component, then there are 0.50 grams of carboxylic acid and 0.25 grams of salt of carboxylic acid in the composition and the total weight of the hydraulic component solids and the flow time retention agent is 100.75 grams.

In embodiments of the invention, the amount of the carboxylic acid and/or carboxylate salt can be, e.g., as listed in TABLE 9 below. In TABLE 9, an “X” represents the range “from about [corresponding value in first row] to about [corresponding value in first column].” The indicated values represent percentage by weight of the hydraulic component. For ease of presentation, it will be understood each value represents “about” that value. For example, the first “X” is the range “from about 0.05% by weight to about 1.00% by weight of the hydraulic component.” A more preferred dosage of carboxylic acid and/or carboxylate salt based flow time retention agent dosage is about 0.1% by weight to about 0.75% by weight of the hydraulic component. The most preferred dosage of carboxylic acid and/or carboxylate salt based flow time retention agent is about 0.15% by weight to about 0.50% by weight of the hydraulic component. Thus, the total amount of carboxylic acid and/or salt can have a range between and including any of the aforementioned endpoints as listed in TABLE 9.

TABLE 9

| | 0.1 | 0.1 | 0.2 | 0.5 | 0.8 | 1 |
|---|---|---|---|---|---|---|
| 0.05 | X | | | | | |
| 0.1 | X | X | | | | |
| 0.2 | X | X | X | | | |
| 0.5 | X | X | X | X | | |
| 0.8 | X | X | X | X | X | |
| 1 | X | X | X | X | X | X |

The extended flow time retention agents of the present invention are particularly beneficial when operational conditions and parameters of a given manufacturing process provide wet hydrophobic coating mixtures having high temperatures of up to 150° F. In absence of the extended flow time retention agents of the present invention, the high temperature of the wet hydrophobic coating mixtures is responsible for rapid material gelation and premature loss in material flow and processing properties. The addition of extended flow time retention agents of the present invention to the hydrophobic coating compositions of the invention allows the high temperature coatings to retain their flow and processing properties for an extended duration thus making the manufacturing processes commercially viable.

Advantageously, during manufacture of the cementitious articles of the present invention, the coating composition stays fluid and workable for at least 30 minutes or longer, preferably at least 60 minutes or longer, more preferably at least 120 minutes or longer, and most preferably at least 240 minutes or longer without stiffening.

The hydrophobic finish composition of this invention stays fluid and workable at a particular hydrophobic finish coating temperature for a time of at least 30 minutes, preferably at least 60 minutes, more preferably at least 120 minutes, and most preferably at least 240 minutes. The particular hydrophobic finish coating temperature being at least one of the following listed coating temperatures: about 70° F., preferably about 90° F., more preferably about 110° F., still more preferably about 130° F., and most preferably about 150° F.

A typical family of carboxylic acids for the present invention includes those wherein R In above-listed chemical formula (II) is a C1-C20 alkyl or C1-C12 alkyl. However, preferably the carboxylic acids and/or salts of carboxylic acids used as extended flow time retention agents in the present invention are other than saturated carboxylic acids of formula RCOOM wherein R is H or C1 to C20 alkyl or C1-C12 alkyl, and M is H, and salts thereof. The saturated carboxylic acids of formula RCOOM and/or salts thereof are optional, and typically not included in compositions of the present invention.

The present carboxylic acids and/or salts of carboxylic acids differ from polycarboxylates, sulfonated melamines, and sulfonated naphthalenes disclosed as superplasticizers in US20140272402 to Dubey et al, Cementitious Article Comprising Hydrophobic Finish. For example, they differ from superplasticizers such as ADVA CAST and ADVA CAST 500 polycarboxylate ether superplasticizers by Grace Construction Products, Cambridge, Mass., SIKA VISCOCRETE G2 polycarboxylate ether superplasticizer from SIKA Corporation, Lyndhurst, NJ, ETHACRYL M and ETHACRYL G polycarboxylate ether superplasticizer from available from Coatex-Arkema, Genay, France, MELFLUX PCE239, MELFLUX PCE 541 polycarboxylate ether superplasticizer from BASF, Trostberg, Germany, and DILOFLO GW Superplasticizer of Geo Specialty Chemicals, Cedartown, Ga. which is a sodium salt of sulfonated naphthalenesulfonate. It is noteworthy that the inventors found polycarboxylate ether superplasticizers that are extremely effective as flow control and water reducing admixtures in conventional cement-based materials and concrete were of little benefit or even disruptive to the flow behavior of compositions of this invention. This finding is unexpected and surprising since polycarboxylate ether based superplasticizers are known in the art for producing cementitious mixtures possessing extremely good flow behavior. Surprisingly, addition of polycarboxylate ether superplasticizers in compositions of the invention was found to increase coating viscosity and (Sheen Cup) flow time substantially.

The carboxylic acids and/or salts of carboxylic acids used as extended flow time retention agents of the present invention are other than copolymerizable unsaturated carboxylic acids and/or salts of copolymerizable unsaturated carboxylic acids. For example they are other than acrylic acids and/or methacrylic acids or salts thereof.

The carboxylic acids and/or salts of carboxylic acids used as extended flow time retention agents of the present invention are preferably other than copolymerizable unsaturated carboxylic acids and/or salts of copolymerizable unsaturated carboxylic acids such as those of structural formula (IV):
monocarboxylic acid monomers according to structure (IV):

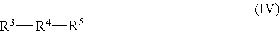

wherein:
R³ is a moiety having a site of ethylenic unsaturation.
R⁴ is absent or is a bivalent linking group, and
R⁵ is a moiety that comprises at least one carboxylic acid group (also known as a carboxyl group (C(O)OH)),

More particularly, the carboxylic acids and/or salts of carboxylic acids used as extended flow time retention agents of the present invention are preferably other than copolymerizable unsaturated carboxylic acids and/or salts of copolymerizable unsaturated carboxylic acids such as those of structural formula (V):

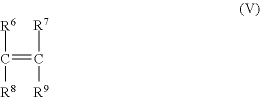

wherein R⁶, R⁷, R⁸ are H or substituted or unsubstituted functional groups, and R⁹ is a functional group containing a carboxyl group (C(O)OH), or polymerized versions thereof, or salts thereof. Thus, for example, carboxylic acids and/or salts of carboxylic acids used as extended flow time retention agents of the present invention are other than methacrylic acid of structural formula (VI):

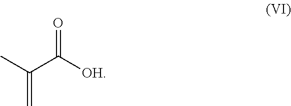

### Silane Compound

Silane compound is optionally included in the hydrophobic finish composition in accordance with the present invention. The silane is preferably within the general chemical formula (I):

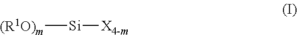

where R¹O is an alkoxy group, X is an organofunctional group, and m ranges from 1 to 3. With respect to the RO alkoxy group, in some embodiments, typically RO is a C1-C8 alkoxy, for example R can be methoxy or ethoxy, although other alkoxy groups are contemplated and can be included. The X organofunctional group can be any such hydrophobicity providing group, such as C1-C12 alkyl, for example, methyl, ethyl, propyl, butyl, pentyl, hexyl or octyl. Long-chain organofunctional groups such as butyl, pentyl, hexyl and octyl groups are preferably selected in some embodiments of the invention for their beneficial role in providing enhanced hydrophobicity. Typically, the silane compound (e.g., alkyl alkoxysilane) has a molecular weight of at least about 150 Daltons.

Preferably, the silane compound is one or more of octyltriethoxy silane, isooctyltriethoxy silane, octyltrimethoxy silane, isooctyltrimethoxy silane, butyltriethoxy silane, isobutyltriethoxy silane, butyltrimethoxy silane, or isobutyltrimethoxy silane.

While not being bound by any theory, it is believed silane compounds with long-chain organofunctional groups X, for example butyl, pentyl, hexyl and octyl groups, are relatively more stable in the finish composition of embodiments of the present invention and therefore provide superior water repellency characteristics. Silanes crosslink or bond to inorganic surfaces through elimination of the alkoxy groups after hydrolysis and condensation reaction. The alkoxy groups react with themselves and any hydroxy (OH) groups within the substrate when moisture is present, forming a silicone resin network. This formation of strong chemical bonds provides long term durability such as might be characteristics of silicone treatments. However, in some embodiments, although generally less preferred, and excluded in some embodiments, it may be possible to utilize small-chain organofunctional groups such as methyl although their use may lead to less desirable hydrophobicity and anti-water penetration properties.

In some embodiments, silane compound (e.g., alkyl alkoxysilane) according to the invention is characterized by a molecular weight of at least about 150, preferably at least about 175, at least about 200, at least about 225, or greater. The silane compound can be added to the mixture either in a concentrated form or in the form of an emulsion, as one of ordinary skill in the art will readily appreciate.

Some examples of suitable alkyl alkoxysilane compounds in accordance with embodiments of the invention include, for example, octyltriethoxy silane, isooctyltriethoxy silane, octyltrimethoxy silane, isooctyltrimethoxy silane, butyltriethoxy silane, isobutyltriethoxy silane, butyltrimethoxy silane, or isobutyltrimethoxy silane, or any combination thereof. In some embodiments, mixtures of silanes and siloxane compounds can be utilized to provide the desired degree of water penetration resistance to the panels of the invention.

Silane compound can be present in accordance with embodiments of the invention in an amount of about 5% by weight or less of the wet finish composition (total composition including its water). Preferably, the silane compound is in an amount from about 0.1% to about 5% by weight of the wet finish composition.

In embodiments of the invention, the amount of the silane compound can be, e.g., as listed in TABLE 10 below. In the table, an “X” represents the range “from about [corresponding value in first row] to about [corresponding value in first column].” The indicated values represent percentage by weight of the wet finish composition. For ease of presentation, it will be understood each value represents “about” that value. For example, the first “X” is the range “from about 0.1% by weight of the wet finish composition to about 0.5% by weight of the wet finish composition.” Thus, the amount of silane compound can have a range between and including any of the aforementioned endpoints as listed in TABLE 10.

TABLE 10

| | 0.1 | 0.5 | 1 | 1.5 | 2 | 2.5 | 3 | 3.5 | 4 | 4.5 |
|---|---|---|---|---|---|---|---|---|---|---|
| 0.5 | X | | | | | | | | | |
| 1 | X | X | | | | | | | | |
| 1.5 | X | X | X | | | | | | | |
| 2 | X | X | X | X | | | | | | |
| 2.5 | X | X | X | X | X | | | | | |
| 3 | X | X | X | X | X | X | | | | |
| 3.5 | X | X | X | X | X | X | X | | | |
| 4 | X | X | X | X | X | X | X | X | | |
| 4.5 | X | X | X | X | X | X | X | X | X | |
| 5 | X | X | X | X | X | X | X | X | X | |

### Other Additives for the Hydrophobic Finish

For embodiments employing hydraulic component one or more inorganic fillers and aggregates can optionally be included in the hydrophobic finish composition of some embodiments, e.g., to reduce cost and decrease shrinkage cracking. Typical fillers include sand, talc, mica, calcium carbonate, calcined clays, pumice, crushed or expanded perlite, volcanic ash, rice husk ash, diatomaceous earth, slag, metakaolin, and other pozzolanic materials. Amounts of these materials should not exceed the point where properties such as strength are adversely affected. For example, in some embodiments, the cumulative amount of aggregate or inorganic filler is about 50% or less by weight of the wet (composition including water) finish composition, such as, for example, about 45% or less, about 30% or less, about 20% or less, about 10% or less, about 5% or less, about 2% or less, about 1% or less, or about 0.1% or less.

For embodiments employing or not employing hydraulic component the following typical additives may optionally be included.

Optionally, water reducing admixture additives can be included in embodiments of the finish composition, such as, for example, superplasticizer, to improve the fluidity of the hydrophobic finish. Typical superplasticizers are selected from any of polycarboxylate ether (PCE) superplasticizers, sulfonated melamines, sulfonated naphthalenes, and any combination thereof. Such additives disperse the molecules in solution so that they move more easily relative to each other, thereby improving the flowability of the entire slurry. PCE superplasticizers, sulfonated melamines, and sulfonated naphthalenes disclosed as superplasticizers in US20140272402 to Dubey et al. U.S. Pat. No. 7,776,462 to Liu et al. discloses examples of PCE superplasticizers.

Optionally, the water reducing additives can include polyacid hydrophobic copolymer dispersants. These copolymer dispersants are typically supplied in the neutralized from using either ammonium or alkali metal salts. For example, acrylic polymers, polycarboxylate, and sodium salt thereof, all provide dispersant efficiency and impart great water resistance.

The polymeric anionic dispersant, which is a polymer functionalized with more than one anionic group, promotes the formation of a stable aqueous dispersion of the pigment particles. As distinct from surfactants, polymeric anionic dispersants comprise a plurality of anionic groups, preferably at least 5 anionic groups per molecule. Consequently, surfactants lower air-water or oil-water surface tension whereas dispersants do not significantly lower surface tension.

Examples of suitable dispersants include salts of a) a homopolymer or a copolymer a carboxylic acid monomer; b) a copolymer of maleic anhydride and diisobutylene; c) a copolymer of styrene and maleic anhydride; d) carboxymethyl cellulose; and e) a homopolymer or copolymer with a plurality of sulfate, sulfonate, phosphate, or phosphonate groups, or combinations thereof, attached to the polymer or copolymer backbone.

Suitable carboxylic acid monomers include acrylic acid, methacrylic acid, or itaconic acid, or a combination thereof as well as anhydrides of carboxylic acid monomers, such as methacrylic anhydride and maleic anhydride. Acrylic acid is a preferred carboxylic acid monomer. Examples of monomers suitable to form carboxylic acid functionalized copolymers include nonionic acrylate or methacrylates such as ethyl acrylate, butyl acrylate, methyl methacrylate, butyl methacrylate, 2-ethylhexyl acrylate, and benzyl methacrylate, and combinations thereof.

The weight average molecular weight (M_{w}) of the dispersant is typically in the range of from 2000 Daltons to 300,000 Daltons, more preferably to 200,000 Daltons as measured by size exclusion chromatography using polyacrylic acid standards ranging in molecular weight from 216 g/mol to 1,100,000 g/mol.

When present, the water reducing admixture additives can be included in the hydrophobic finish of the present invention in an amount (on a wet basis of the total hydrophobic finish) of about 0.05 wt. % to about 5 wt. %, preferably about 0.1 wt. % to about 2 wt. %, and more preferably about 0.1 wt. % to about 1 wt. %. In some instance, the hydrophobic finish of the present invention has an absence of water reducing admixture additives.

Colorants optionally can be added to the hydrophobic finish of the present invention to change the color of the composition or finished articles as desired. Any dyes or pigments that are compatible with the composition and non-setting may be optionally used. Titanium dioxide is optionally used as a whitener. A preferred colorant is AQUABLAK® (an activated carbon dispersion, available from Solution Dispersions). Pigments which may be used are all pigments known to a person skilled in the art for the intended use. Typical pigments for the aqueous formulations according to the invention are, for example, titanium dioxide, preferably in the form of rutile, barium sulfate, zinc oxide, zinc sulfide, basic lead carbonate, antimony trioxide and lithopone (zinc sulfide and barium sulfate). However, the aqueous formulations can also contain colored pigments, for example iron oxides, carbon black, graphite, luminescent pigments, zinc yellow, zinc green, ultramarine, manganese black, antimony black, manganese violet, Paris blue or Schweinfurt green. In addition to the inorganic pigments, the formulations according to the invention may also contain organic colored pigments, for example sepia, gamboge, Kasset brown, toluidine red, para red, Hansa yellow, indigo, azo dyes, anthraquinoid and indigoid dyes and dioxazine, quinacridone, phthalocyanine, isoindolinone and metal complex pigments.

When present, the colorants can be included in the hydrophobic finish of the present invention in an amount (on a wet basis of the total hydrophobic finish) of about 0.05 wt. % to about 2 wt. %, preferably about 0.1 wt. % to about 1 wt. %, and more preferably about 0.1 wt. % to about 0.5 wt. %. In some instance, the hydrophobic finish of the present invention has an absence of colorants.

Biocides optionally can be added to the hydrophobic finish of the present invention to mitigate bacteria growth in the wet hydrophobic finish. A preferred biocide include, but are not limited to, 2[(hydroxymethyl)amino]-2-methylpropanol; 3-iodo-2-propnynyl butyl carbamate; n-(3,4-dichlorophenyl)-n,n-dimethlyurea; 1,2 benzisothiazolin-3-one; and any combination thereof.

When present, the biocides can be included in the hydrophobic finish of the present invention in an amount (on a wet basis of the total hydrophobic finish) of about 0.05 wt % to about 0.5 wt %, and preferably about 0.1 wt % to about 0.25 wt %. In some instance, the hydrophobic finish of the present invention has an absence of biocides.

Mildewcides optionally can be added to the hydrophobic finish of the present invention to mitigate mildew formation on the dried hydrophobic finish coating. An example mildewcide is ZINC OMADINE™ ZOE™ (an antimicrobial available from Lonza).

When present, the mildewcides can be included in the hydrophobic finish of the present invention in an amount (on a wet basis of the total hydrophobic finish) of about 0.05 wt % to about 0.3 wt %, and preferably about 0.1 wt % to about 0.25 wt %. In some instance, the hydrophobic finish of the present invention has an absence of mildewcides.

Optionally, defoamers are used to reduce entrapped air bubbles in the process. Polymers can entrap air during transportation and mixing. Fillers such as calcium carbonate can have air between the particles. Liquid defoamers can be added to the hydrophobic finish of the present invention. A defoamer or an anti-foaming agent is a chemical additive that reduces and hinders the formation of foam in industrial process liquids. The additive is used to prevent formation of foam or is added to break a foam already formed. The terms anti-foaming agent and defoamer are often used interchangeably. Typical liquid defoamers are one or more of oil based, water based, silicone based, Ethylene Oxide/Propylene Oxide based, or alkyl polyacrylate based defoamers. For example, they may be alkoxylated alcohol, petroleum distillates, mixtures of paraffinic mineral oils and hydrophobic components, polysiloxanes and hydrophobic solids in polyglycol, and polydimethylsiloxanes, for example polydimethylsiloxane or polyether-modified polydimethylsiloxane. They can be used alone, or as a combination. Silicone-based defoamers are polymers with silicon backbones. The silicone compound consists of hydrophobic silica dispersed in a silicone oil. Commonly used defoaming agents are polydimethylsiloxanes, for example polydimethylsiloxane, and other silicones. Emulsifiers are added to ensure the silicone spreads fast and well in the foaming medium. The silicone compound might also contain silicone glycols and other modified silicone fluids. Another possible defoamer is a mixture of foam-destroying polysiloxanes and hydrophobic solids in polyglycol. However, there can be an absence of silicone-based defoamers.

Typical examples of such alkoxylated alcohol defoaming agents include propoxylates and butoxylates of aliphatic alcohols containing from 4 to 36 carbon atoms. Typically antifoaming agents include non-ionic surfactants having a 0-3 HLB Value. DE 3018173 relates to highly alkaline, storage stable, and low-foaming solid cleaning compositions comprising a branched C12-022 alcohol based detergent with 5-15 PO units. An especially preferred product was stated to be C16 Guerbet alcohol reacted with 10 moles of propylene oxide. US 2005/0215452 relates to the use of a C10 alkanol alkoxylate mixture as emulsifier, foam regulator and wetting agent. Specifically 2-propylheptanol propoxylates with up to 1.71 PO are disclosed, though products including both PO and EO units are preferred.

When present, the defoamers can be included in the hydrophobic finish of the present invention in the amount (on a wet basis of the total hydrophobic finish) of about 0.05 wt. % to about 2 wt. %, preferably about 0.1 wt. % to 1.5 wt. %, more preferably about 0.2 wt. % to about 1 wt. %. Typically, when present, the defoamer dosage can be in an amount (on a wet basis of the total hydrophobic finish) of 0-1% by weight of the total coating weight, preferably 0.1-1% by weight of the total coating weight, more preferably 0.2-0.8% by weight of the total coating weight. The hydrophobic finish of the present invention may have an absence of silicone based defoamers. The hydrophobic finish of the present invention may have an absence of defoamers.

### Methods of Making the Hydrophobic Finish

To make the hydrophobic finish coating comprising the hydraulic component comprising fly ash components are combined and mixed in a mixer until a homogeneous blend is obtained. After mixing, the flowable slurry of hydrophobic finish exits from the mixer and can be applied to the at least partially set core layer.

To make the non-setting, hydrophobic finish, components are combined and mixed until a homogeneous blend is obtained. Preferably, the mixer is a high shear mixer providing a short residence time. Because the inventive non-setting, hydrophobic finish is a drying finish, mixing and subsequent application methods may be done in batch rather than continuously. For example, a batch mixer is preferred in some applications, particularly where the slurry must be fed to more than one area of the manufacturing line. The wet ingredients are charged to the mixer, followed by the dry components. After mixing, the entire batch is dumped into a pot for continuous distribution to the line. If distribution to more than one location is desired, multiple pumps with separate destinations can be used to distribute hydrophobic finish slurry from the pot for applying to the at least partially set core layer.

For either type of hydrophobic finish the film forming polymer may be added as a dispersion including from about 30 to about 75% solids and typically having a mean polymer particle size of from about 70 to about 650 nm. The polymer is preferably present in the aqueous coating composition in an amount from about 5 to about 60 percent by weight, and more preferably from about 8 to about 40 percent by weight.

### Methods of Applying the Hydrophobic Finish

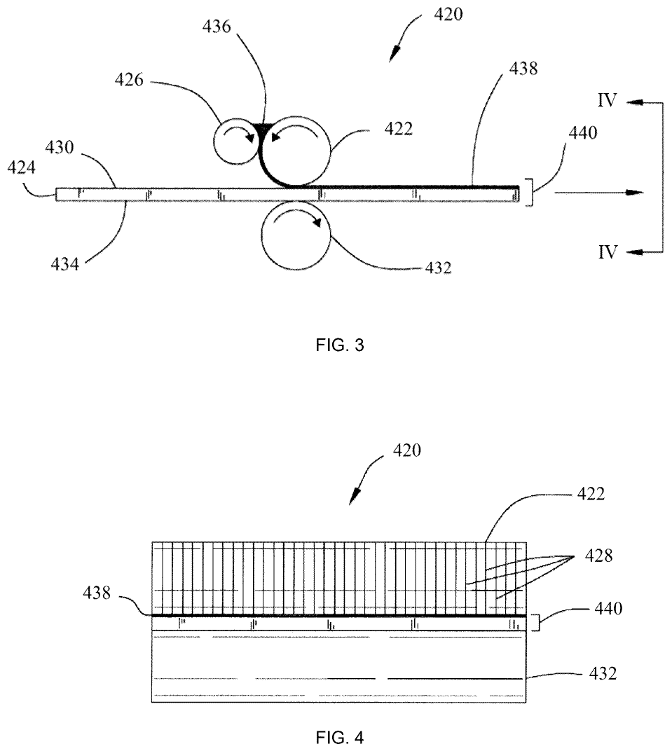

FIG. 3 shows a schematic side view illustrating a roller assembly for making a composite board of the present invention comprising a finish roller with circumferential grooves defined therein applying a hydrophobic finish composition to a mat faced cementitious board with the assembly in a direct finish orientation, in accordance with an embodiment of the invention.

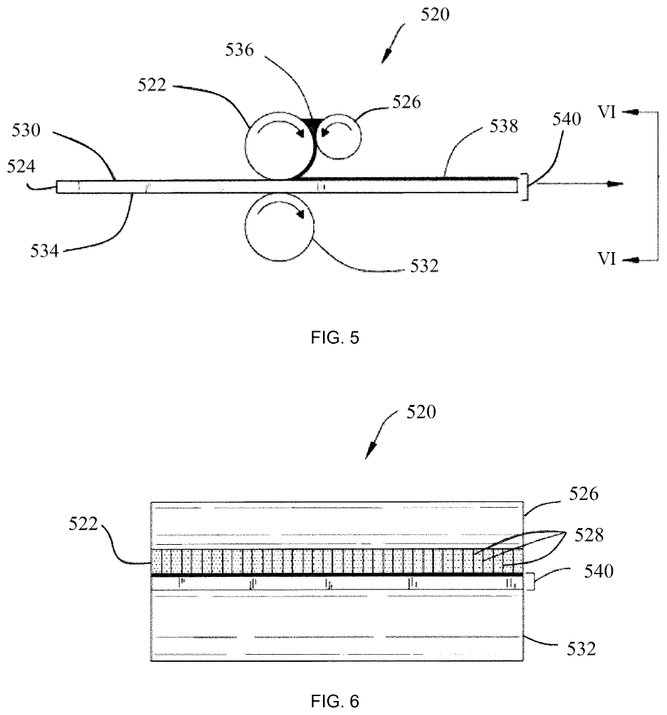

FIGS. 3-4 depicts an exemplary apparatus for applying hydrophobic finish composition to a gypsum fiber board. FIGS. 3-4 show a direct application orientation of a roller assembly 420 such that a finish roller 422 rotates in the same direction that the gypsum fiber board 430 travels as described below. Thus, the finish roller 422 rotates in a direction so its surface moves in the same direction as the board moves. In contrast, in reverse finishing configurations, described below in connection with FIGS. 5A-5B, the finish roller rotates in reverse so its surface in contact with the gypsum fiber board moves in the opposite direction that the board moves.

FIG. 3 shows roller assembly 420 also includes a doctor roller 426 which engages finish roller 422. Rollers 422 and 426 are mounted with brackets journaled to allow for rotation and extend from columns mounted on the building floor or table on which the board travels. One or both of the rollers 422 and 426 are driven by a motor. In some embodiments, the finish roller 422 and doctor roller 426 are driven, for example, by independent, variable speed, drive assemblies. This can be advantageous in some embodiments to allow the finish roller 422 speed and doctor roller 426 speeds to be varied independently, as desired. In other embodiments, one of the rollers 422 or 426 is driven while the other roller 422 or 426 is an idler such that it rotates by engagement with the driven roller to rotate in response to the roller being driven.

The doctor roller 426 engages with the finish roller 422. Particularly, the doctor roller 426 mates with the finish roller 422 to form a trough between the two, where the finish composition is introduced. The finish roller 422 and the doctor roller 426 generally counter-rotate (i.e., rotate in opposite directions relative to one another) both in direct finishing or reverse finishing configurations (described below). Having the finish roller 422 and doctor roller 426 engage in this manner facilitates keeping the slurry for the hydrophobic, non-setting coating in the gap between the two rollers so that the slurry for the hydrophobic, non-setting coating does not spill. The position of the doctor roller 426 is adjusted relative to the finish roller 422. This may result in a small gap between the two rollers, which can be adjusted to control the amount of slurry allowed to pass between them, which in turn influences the amount of finishing composition to be applied. If desired, particularly in direct finishing arrangement, this gap may actually be negative indicating an interference fit as that term is understood in the art, thereby indicating that the doctor roller 426 is touching, and compressing the surface of, the finish roller 422.

FIG. 4 shows the finish roller 422 includes grooves 428 circumferentially disposed in the surface of the finish roller 422. In the direct application orientation, doctor roller 426 is upstream of finish roller 422 to minimize the surface area of finish roller 422 bearing the finish composition. In this respect, it has been found that increasing the surface area (beyond, for example, 90 degree, 100 degree, 120 degree, etc.) of the portion of finish roller 422 that bears finish composition increasingly results in undesirable variation in the finish application. A top surface 430 of the board 424 as shown is adjacent to the finish roller 422. A bottom roller 432 is disposed under a bottom surface 434 of the board 424. The board is generally supported by a roller conveyor, chain conveyor, belt conveyor, or the like at the pass line height (i.e., the same elevation as the top of the bottom roller 432). For example, the bottom roller 432 can optionally work in concert with other rollers which help transport board into and out of the assembly roller 420.

Hydrophobic finish composition is dispensed between finish roller 422 and doctor roller 426 to feed the composition between the finish roller 422 and doctor roller 426 and onto the surface of the finish roller 422 for application to top surface 430 of board 424. A head 436 of the hydrophobic finish composition slurry forms between the doctor roller 426 and the finish roller 422. The head can be controlled by a sensor such as laser control as understood in the art. The surface of the finish roller 422 pulls finish composition onto the board 424 to deposit the finish composition onto the top surface 118 to lay a finish 438 and form a composite 440. The bottom roller 432 provides underlying support and is generally aligned under the finish roller 422.

FIGS. 5-6 depict another exemplary apparatus for applying a finish composition to a gypsum fiber board 524. This shows a reverse application orientation of a roller assembly 520 such that a finish roller 522 rotates in the opposite or counter direction that the gypsum fiber board 524 travels. Roller assembly 520 includes a doctor roller 526 which engages with finish roller 522 in counter-rotation. As best seen in FIG. 5B, the finish roller 526 includes grooves 528 circumferentially disposed in the surface of the roller 522. In the reverse application orientation, doctor roller 526 is downstream of finish roller 522 to minimize the surface area of the finish roller 526 that bears the finish composition. A top surface 530 of the gypsum fiber board 524 as shown is adjacent to the finish roller 526. A bottom roller 532 is disposed under a bottom surface 534 of the gypsum fiber board 524. The bottom roller 532 may have a cover formed from, for example, rubber or elastomeric material such as neoprene, to achieve traction on the bottom surface 534, to ensure gypsum fiber board 524 travels at the desired speed and desired direction, despite the frictional force of the finish roll 522.

Finish composition is dispensed between finish roller 522 and doctor roller 526. A head 536 of the hydrophobic finish composition slurry forms between the doctor roller 526 and the finish roller 522. The finish roller 522 acts to apply the finish composition onto the top surface 530 to lay a finish 538 and form a composite coated gypsum fiber board 540. Other aspects of the embodiment set forth in FIGS. 5A-5B, such as driver for the roll, the mounting thereof, and the presence of other bottom rollers, are similar to the description set forth relative to FIGS. 3-4 as described above.

Generally, in the apparatus shown in FIGS. 3 and 4 as well as the apparatus shown in FIGS. 5 and 6, doctor roller 426 or 526 has a smaller diameter than finish roller 422 or 522. This is because the highest elevation of both the doctor roller 426 and finish roller 422 typically is at the same elevation (or with axes at substantially coinciding elevation), and the lowest elevation of the doctor roller 426 or 526 should be higher than the surface to be finished, to avoid interference with the article being finished. The grooves 428 and 528 can be in any suitable configuration. For example, the finish roller 422 or 522 can comprise a buttress thread form to define the grooves in some embodiments. In embodiments including the buttress thread configuration, any suitable buttress thread count per longitudinal inch of the roller can be used.

In these apparatus, each roller piece in the roller assembly can be independently driven and varied to allow fine tuning of the finishing. As noted herein, the bottom roller can optionally be a part of a larger section of rollers used in conveyors for moving board down a manufacturing line. For example, if desired, a series of rollers can be driven with one drive and linked together (e.g., with chains, belts, or the like). However, in some embodiments, the bottom roller can have its speed independently varied relative to other conveying rollers to thereby allow more precise control of the bottom roller of the roller assembly of embodiments of the invention (e.g., to regulate the speed of the bottom roller to correspond with the speed of the board).

The bottom roller is a supporting roller opposing the finish roller. For example, the finish roller advantageously can keep the board being treated with finish composition at the desired elevation (path line height) while also enhancing traction to drive the board in the proper direction at a substantially constant rate down the manufacturing line. The bottom roller further facilitates having an even finish thickness on the outer surface of the board. For example, the roller reduces the chance for roller slippage over the board to which the finish is being applied. Such slippage can undesirably result in variation in thickness of the applied finish composition. In some embodiments, as an alternative to a bottom roller, a plate such as an anvil plate can be used.

The vertical gap between the finish roller and bottom roller can be adjusted to accommodate different clearances between them, for example, to accommodate different board thickness. In some embodiments, the bottom roller remains stationary while the finish roller is moved up and down to adjust the gap. However, other variations are possible, including having the height of the bottom roller adjustable or having both the finish roller and the bottom roller being adjustable.

The doctor roller typically is formed at least in part with suitable metal. For example, in some embodiments, the metal is steel such as stainless steel to avoid rusting given that the finish composition is normally in the form of aqueous slurry. The surface can be plated with chrome or the like to allow the doctor roller to remain as clean as possible in operation.

The composition of the finish roller may vary, for example, depending on whether a direct finishing or reverse finishing arrangement is employed. For example, in some embodiments of a direct finishing arrangement, the finish roller can be formed of metal with a softer cover such as formed from one or more rubbers or elastomeric material such as neoprene, ethylene propylene diene monomer (EDPM) rubber, or the like. In this respect, it is understood that the article to be finished, including mat-faced board, are not perfectly flat because of, for example, surface imperfections. Thus, in accordance with embodiments of the invention, a cover (e.g., made of rubber material) can be used to conform to surface imperfections in the board or other article to allow for an even more finish. Rubbers are desirable materials for this purpose because of compressibility property and long wear life. They also tend to be materials that are easy to keep clean. The use of a steel finish roller can be less desirable in some embodiments of direct finishing arrangements. For example, where surface imperfections are prevalent, a steel finish roller is less apt to conform to the surface. The applied finish will have variation with a thicker finish being observed where there are depressions in the board surface and a thinner finish observed where there are protrusions in the board surface.

However, in some instances, such as some reverse finish arrangements, the finish roller can be formed from metal such as steel to reduce wear. In this respect, where the finish roller is rotating in a direction opposite as the board is traveling, the finish roller will exhibit undesirable wear characteristics in operation if the finish roller is made of softer material such as rubber. Furthermore, a rubber finish roller may at times create excessive traction such that the board undesirably could be pushed backwards.

It will be understood the grooves, if present, can be in any suitable configuration. Grooves advantageously allow for more surface area for hydrophobic finish (Hydrophobic coating) to be applied. The grooves can be cut into the rubber cover and/or into a metal roller in various embodiments, with grooves being particularly advantageous in rubber covered embodiments of finish roller because rubber in some embodiments is easier to clean. In some embodiments, the finish roller comprises a buttress thread form to define the grooves in some embodiments. In embodiments including the buttress thread configuration, any suitable buttress thread count per longitudinal inch of the roller can be used. For example, in some embodiments, the finish roller has from about 4 to about 50 buttress thread per inch of longitude, such as from about 8 to about 12 buttress thread per inch (e.g., about 10 buttress thread per inch).

In some embodiments, the finish roller has a longitudinal axis and the groove(s) are circumferential such that they are perpendicular, or nearly perpendicular, to the axis. The grooves can have any suitable depth, such as a depth from about 0.001 inch to about 0.25 inch (e.g., from about 0.05 inch to about 0.20 inch). The grooves can have any suitable width, for example, from about 0.001 inch to about 0.25 inch, such as from about 0.08 inch to about 0.012 inch.

The size of the rollers can vary. For example, the radius of the finish roller is dependent on the line speed of the article being finished, and the viscosity of the finish composition. The length of the finish roller is dependent on the width of the panels being finished and normally the length of the roller is somewhat longer than the width of the product (e.g., 10 to 15% longer), for example, to ensure the product is finished across the entire width. The radius of the doctor roller may be dependent on the radius of the finish roller, speed of doctor roller, finish viscosity, etc. In some embodiments, the doctor roller has a smaller diameter than the finish roller so its axis is substantially the same elevation as the axis of the finish roller, while its bottom surface is above the top surface of the panel 218. The length of the doctor roller should normally be the same as the length of the finish roller, with dams on the ends of these rollers, to prevent hydrophobic finish composition coating from spilling over.

The finish roller is normally fabricated from steel, and can have one or more covers with any suitable hardness. In some embodiments, the hardness of the finish roller is selected to be softer than the doctor roller to allow the doctor roller to compress the finish roller as the rollers engage which is advantageous in controlling the amount of finish composition to be deposited. For example, the cover(s) can be such that the finish roller can have a hardness of about 100 Durometer or less as determined according to Shore-A, such as about 70 Durometer Shore-A or less (e.g., about 40 Durometer Shore-A) with the doctor roller desirably having higher corresponding hardness value than the selected value for the finish roller in some embodiments. If desired, the finish roller cover(s) comprises neoprene, EPDM, or a combination thereof to help reduce surface hardness while maintaining a harder core in some embodiments. For direct finish configurations, desirably the finish roller can be formed from rubber in order to allow if to conform to the imperfect surface of the board, resulting in a more uniform finishing thickness. In reverse finish configurations, a roller with no cover can be used in some embodiments, for example, a chrome-plated smooth steel finish roller because this allows for greater resistance to wear, while also minimizing frictional force against the top surface 530 of the board 524, and minimizing the amount of finishing adhering on the roller surface.

The gap between adjacent surfaces of the doctor roller and finish roller in some embodiments are in an interference fit such that the gap is defined by a negative number as understood in the art. The negative numbers refer to the amount of interference, for example, the difference between the sum of the outmost radii of the finish roller and the doctor roller, and the actual distance between axes of these two rollers. In some embodiments where the finish roller is generally softer than the doctor roller, the doctor roller can compress the finish roller when the rolls are positioned this way. The gap between the doctor roller and finish roller may be adjusted depending on factors including the viscosity of the finishing composition, the speed of the rollers, and whether direct or reverse roller configurations are employed. In direct roller finishing, the finish roller and the doctor roller are disposed to define a gap therebetween in some embodiments from about +0.010 inch (about +0.025 cm) to about −0.020 inch (about −0.051 cm), such as from about −0.005 inch (about −0.013 cm) to about −0.010 inch (about −0.025 cm), for example, about −0.007 inch (about −0.018 cm). In reverse finishing arrangements, the gaps can be somewhat larger, for example, from zero to about +0.010 inch in some embodiments.

In some embodiments, the roller assembly is configured such that a gap between the finish roller and the bottom roller is less than the average panel thickness by about 0 inch (about 0 cm) to about 0.10 inch (about 0.25 cm), such as by about 0.01 inch (about 0.25 cm) to about 0.08 inch (about 0.20 cm), for example, by about 0.02 inch (about 0.51 cm) to about 0.06 inch (about 0.15 cm).

Methods of applying hydrophobic finish composition also include spraying, curtain coating, and knife coating. The coating can be repeated such that more than one layer of hydrophobic coating can be applied. Thus, for example, 1, 2 or 3 layers of hydrophobic coating can be applied.

### Water Resistance

Preferably the surface water absorption of the boards of the present invention is less than 1.6 grams, more preferably less than 0.5 grams, furthermore preferably less than 0.45 grams, still furthermore preferably less than 0.4 grams, and most preferably less than 0.3 grams, as measured in accordance to ASTM C473. The surface water absorption less than 1.6 g is measured per ASTM C1658. The surface water absorption less than 0.5 g, less than 0.45 g, less than 0.4 g and less than 0.3 g are measured per ASTM C1178.

Preferably boards according to the present invention pass the test for waterproofness under the American National Standards Institute (ANSI) standard ANSI A118.10 (revised, 2014), which modifies ASTM D4068-09 (Annex 2: Hydrostatic Pressure Test). The waterproof test is conducted with a hydrostatic head of 24 inches on the sample. The product according to the invention not only exhibits desirable water resistance properties, but also in some embodiments exhibits waterproofness. As such, product according to embodiments of the invention is useful in applications where such water impermeability property is particularly desirable, as described herein. Passing the waterproofness standard advantageously can allow product in accordance with embodiments of the invention to be used in areas subject to waterproof standards under international building and residential codes.

### Example 1

TABLE 11 shows the samples tested and summarizes test results.

TABLE 11
Water Column Testing (per ANSI A118.10 for Waterproofness)
Water Column Testing of Coated & Uncoated Panels per ANSI A118.10 Standard

| | | Siloxane | Coating | Coating | Drop in | | |
|---|---|---|---|---|---|---|---|
| | Test | Amount | Application | Amount | water level | Pass/ | |
| Trial ID | No. | (pounds/MSF) | Surface | (#/MSF) | (mm) | Fail | Comments |
| Control A | 1 | 5.5 | N/A | None | 16 | Fail | 1 |
| Control A | 2 | 5.5 | N/A | None | 13 | Fail | 1 |
| Trial 1 | 1 | 5.5 | Face | 50 | 0 | Pass | 2 |
| Trial 1 | 2 | 5.5 | Face | 50 | 0 | Pass | 2 |
| Trial 2 | 1 | 5.5 | Back | 50 | 0 | Pass | 2 |
| Trial 2 | 2 | 5.5 | Back | 50 | 0 | Pass | 2 |
| Trial 3 | 1 | 5.5 | Face | 100 | 0 | Pass | 2 |
| Trial 3 | 2 | 5.5 | Face | 100 | 0 | Pass | 2 |
| Trial 4 | 1 | 5.5 | Face | 100 | 0 | Pass | 2 |
| Trial 4 | 2 | 5.5 | Back | 100 | 0 | Pass | 2 |

Comment 1 - Clearly visible water spots on the opposite surface.
Comment 2 - No visible water spots

### Trial Condition Descriptions:

Base panel-½″ Fiberock Gypsum Fiber Board at nominal 2500 lbs/MSF weight with 5.5 lbs/MSF siloxane added for water resistance.

The coating formulation was as follows:
RHOPLEX AC-1034—79.94% (styrenated acrylic copolymer emulsion)
ZOE (zinc omadine)—0.09% (mold resistant agent)
Colorant—0.07%
Dispersant—1.04%
Defoamer—0.41%
AMP-95—0.55% (an amino alcohol used as a pH stabilizer) (2-amino-2-methyl-1-propanol in a 5% aqueous solution)

The coating application rates were as follows:
Trial 1 (panel face) and Trial 2 (panel back) at 50 lbs/MSF
Trial 3 (panel face) and Trial 4 (panel back) at 100 lbs/MSF

The coating was applied in a single pass using roller coater equipment in a continuous operation on an industrial production line. The coating was applied at a line speed of about 50 feet/minute. Right after the application of coating, the coating was dried using a hot air convection oven situated on the continuous production line. The residence time of the panels in the drying oven was approximately one minute. The panels were successfully stacked on top of each other at the end of the line without any signs of adjacent panels sticking to each other caused by insufficiently dried coating. The total residence time of panels on the continuous line prior to panel stacking was approximately 10-15 minutes.

Water Column Testing—Uncoated control panels failed the water column test as indicated, while all Trial coated levels provided passing results with no drop in water levels or visible water penetration on the panel bottoms after testing.

### Example 2

TABLE 12 shows the samples tested and summarizes test results.

TABLE 12
Water Column Testing (per ANSI A118.10 for Waterproofness)
Water Column Testing of Coated and Uncoated Panels per ANSI A118.10 Standard

| | | Siloxane | Coating | Coating | Drop in | | |
|---|---|---|---|---|---|---|---|
| | Test | Amount | Application | Amount | water level | Pass/ | |
| Trial ID | No. | (pounds/MSF) | Surface | (#/MSF) | (mm) | Fail | Comments |
| Control A | 1 | 5.5 | N/A | None | 16 | Fail | 1 |
| Control A | 2 | 5.5 | N/A | None | 13 | Fail | 1 |
| Trial 2 | | 5.5 | Back | 50 | 0 | Pass | 2 |
| Trial 8 | | 10.0 | Back | 50 | 0 | Pass | 2 |
| Trial 10 | | 15.0 | Back | 50 | 0 | Pass | 2 |

Comment 1 - Clearly visible water spots on the opposite surface.
Comment 2 - No visible water spots.

### Trial Condition Descriptions:

Base panel-½″ FIBEROCK Gypsum Fiber Board at nominal 2500 lbs/MSF weight with 5.5, 10.0, and 15.0 lbs/MSF siloxane added for water resistance.

The coating formulation was as follows:
RHOPLEX AC-1034—79.94% (styrenated acrylic copolymer emulsion)
ZOE (zinc omadine)—0.09% (mold resistant agent)
Colorant—0.07%
Dispersant—1.04%
Defoamer—0.41%
AMP-95—0.55% (an amino alcohol used as a pH stabilizer)

The coating application rates were as follows:
Trial 2, Trial 8, and Trial 10 at 50 lbs/MSF

The coating was applied in a single pass using roller coater equipment in a continuous operation on an industrial production line. The coating was applied at a line speed of about 50 feet/minute. Right after the application of coating, the coating was dried using a hot air convection oven situated on the continuous production line. The residence time of the panels in the drying oven was about one minute. The panels were successfully stacked on top of each other at the end of the line without any signs of adjacent panels sticking to each other caused by insufficiently dried coating. The total residence time of panels on the continuous line prior to panel stacking was about 10-15 minutes.

Water Column Testing—Uncoated control panels failed the water column test as indicated. All Trial coated levels provided passing results with no drop in water levels or visible water penetration on the panel bottoms after testing.

### Example 3

Coating was applied to the panel faces at 100 lbs/MSF using two different methods as follows:
Trial 3 panels with one full coat at 100 lbs/MSF; and
Trial 11 panels with two discrete coats at 50 lbs/MSF per coat. The second coat applied at a 90 degree rotation relative to the first coat and subsequent to the drying of the first coat.

TABLE 13 shows the samples tested and summarizes test results.

TABLE 13
Water Column Testing (per ANSI A118.10 for Waterproofness)
Water Column Testing of Coated Panels per ANSI A118.10 Standard

| | | Siloxane | Coating | Coating | | | |
|---|---|---|---|---|---|---|---|
| | Test | Amount | Application | Amount | # of | | Pass/ |
| Trial ID | No. | (#/MSF) | Surface | (#/MSF) | Coats | Coating Orientation | Fail |
| Trial 3 | 1 | 5.5 | Face | 100 | 1 | Machine Direction | Pass |
| Trial 3 | 2 | 5.5 | Face | 100 | 1 | Machine Direction | Pass |
| Trial 11 | 1 | 5.5 | Face | 100 | 2 | Layer #1 - Machine | Pass |
| | | | | | | Direction; Layer #2 - | |
| | | | | | | Perpendicular to | |
| | | | | | | Machine Direction | |
| Trial 11 | 2 | 5.5 | Face | 100 | 2 | Layer #1 - Machine | Pass |
| | | | | | | Direction; Layer #2 - | |
| | | | | | | Perpendicular to | |
| | | | | | | Machine Direction | |

NOTES -
For Trial 3, Test Nos. 1 and 2 the Drop in Water Level (mm) was 0 mm and there were no visible water spots.
For Trial 11, Test Nos. 1 and 2 the Drop in Water Level (mm) was 0 mm and there were no visible water spots.

### Trial Condition Descriptions:

Base panel-½″ Fiberock Gypsum Fiber Board at nominal 2500 lbs/MSF weight with 5.5 lbs/MSF siloxane added for water resistance.

The coating formulation was as follows:
RHOPLEX AC-1034—79.94% (styrenated acrylic copolymer emulsion)
ZOE (zinc omadine)—0.09% (mold resistant agent)
Colorant—0.07%
Dispersant—1.04%
Defoamer—0.41%
AMP-95—0.55% (an amino alcohol used as a pH stabilizer)

The coating application rates were as follows:
Trial 3 at 100 #/MSF (single coat) and Trial 11 at 100 lbs/MSF (two coats—50 #/MSF per coat)

The coating was applied using roller coater equipment in a continuous operation on an industrial production line. The coating was applied at a line speed of about 50 feet/minute. Right after the application of coating, the coating was dried using a hot air convection oven situated on the continuous production line. The residence time of the panels in the drying oven was approximately one minute. The panels were successfully stacked on top of each other at the end of the line without any signs of adjacent panels sticking to each other caused by insufficiently dried coating. The total residence time of panels on the continuous line prior to panel stacking was approximately 10-15 minutes.

Water Column Testing-All Trial coated levels provided passing results with no drop in water levels or visible water penetration on the panel bottoms after testing.

### CLAUSES OF THE INVENTION

The following clauses also describe aspects of the invention.

Clause A1. A gypsum fiber panel (GFP) comprising:
a fiber-reinforced gypsum board core layer comprising:
   gypsum,
   cellulose fibers embedded uniformly throughout the core layer,
   a siloxane level of 0 to about 1.0 wt. %, typically about 0.1 to about 0.9 wt. %, preferably about 0.2 to about 0.8 wt. %, more preferably about 0.2 to about 0.8 wt. %, furthermore preferably about 0.3 to about 0.6 wt. %, most preferably about 0.25 to about 0.50 wt. % uniformly distributed within the gypsum board core layer; and
a hydrophobic coating on the core layer, wherein the hydrophobic coating comprises as ingredients:
a film forming polymer, and
at least one of:
   a non-setting inorganic filler, having a volume mean particle diameter of about 4 microns to about 100 microns, preferably about 6 microns to about 80 microns, more preferably about 8 microns to about 60 microns, most preferably about 10 microns to about 40 microns, and
   a hydraulic component comprising a fly ash,
wherein, if the hydraulic component is present, the hydrophobic coating further comprises at least one member of the group consisting of:
   an extended flow time retention agent comprising at least one member selected from the group consisting of carboxylic acids, salts of carboxylic acids, and mixtures thereof, and
   optionally a silane;
wherein the gypsum fiber panel has no facer mat or mesh on its surface;
wherein the gypsum fiber panel has no embedded mat or mesh.

Clause B2. The gypsum fiber panel of clause A1, wherein the fiber-reinforced gypsum board core layer comprises about 70 to about 93 wt. % gypsum and about 4 to about 20 wt. %, about 5 to about 15 wt. %, about 6 wt. % to about 12 wt. % cellulose fiber.

Clause C3. The gypsum fiber panel of clauses A1 or B2, wherein the fiber-reinforced gypsum board core layer comprises 0.1 to 0.9 wt. % 0.10 to 0.80 wt. % preferably, 0.20 to 0.60 wt. %, more preferably, and most preferably 0.25 to 0.50 wt. % siloxane.

Clause D4. The gypsum fiber panel of any of clauses A1 to C3, wherein the fiber-reinforced gypsum board core layer has a density of 56 to 90 lbs./ft², 57 to 80 lbs./ft², or 58 to 70 lbs./ft².

Clause E5. The gypsum fiber panel of any of clauses A1 to D4, wherein the hydrophobic coating results from curing a layer of hydrophobic finish composition comprising:
about 5 to about 30% by weight water;
about 5% to about 25% by weight said film-forming polymer
about 50% to about 85% by weight said hydraulic component, wherein at least half of the hydraulic component by weight is Class C fly ash; and
at least one member of the group consisting of:
5% by weight or less said silane, and
said extended flow time retention agent in an amount on a dry basis equal to 0.05-1.00 wt. % by weight of said hydraulic component.

Clause F6. The gypsum fiber panel of any of clauses A1 to D4, wherein the hydrophobic coating results from curing a layer of hydrophobic finish composition comprising:
about 7.5 to about 25% by weight water;
about 7.5% to about 22.5% by weight said film-forming polymer
about 55% to about 75% by weight said hydraulic component, wherein at least half of the hydraulic component by weight is Class C fly ash; and
at least one member of the group consisting of:
0 to 3% by weight said silane, and
said extended flow time retention agent in an amount on a dry basis equal to 0.075-0.75 wt. % by weight of said hydraulic component.

Clause G7. The gypsum fiber panel of any of clauses A1 to D4, wherein the hydrophobic coating results from curing a layer of hydrophobic finish composition comprising:
about 10 to about 20% by weight water;
about 10% to about 20% by weight said film-forming polymer;
about 60% to about 70% by weight said hydraulic component, wherein at least half of the hydraulic component by weight is Class C fly ash; and
at least one member of the group consisting of:
0.2 to 1% by weight said silane, and
said extended flow time retention agent in an amount on a dry basis equal to 0.10-0.50 wt. % by weight of said hydraulic component.

Clause H8. The gypsum fiber panel of any of clauses A1 to D4, wherein the hydrophobic coating results from curing a layer of hydrophobic finish composition comprising:
(i) about 50 to about 80 weight % non-setting, inorganic filler having a volume mean particle diameter of about 4 microns to about 100 microns, preferably about 6 microns to about 80 microns, more preferably about 8 microns to about 60 microns, most preferably about 10 microns to about 40 microns,
(ii) about 20% to about 50 weight % an aqueous dispersion of a film-forming polymer,
(iii) 0% to about 30 weight % additional water;
(iv) an absence of fly ash,
(v) an absence of pozzolanic material,
(vi) an absence of hydraulic cement,
(vii) an absence of calcium sulfate hemihydrate, and
(viii) an absence of calcium sulfate anhydrite.

Clause 19. The gypsum fiber panel of any of claims 1 to 5, wherein the hydrophobic coating results from curing a layer of hydrophobic finish composition comprising:
(i) about 50 to about 80 weight % non-setting, inorganic filler having a volume mean particle diameter of about 12 microns to about 35 microns,
(ii) about 20% to about 50 weight % an aqueous dispersion of a film-forming polymer,
(iii) 0% to about 30 weight % additional water.

Clause J10. The gypsum fiber panel of any of clauses A1, H8 or 19, wherein the non-setting, inorganic filler comprises at least one member selected from the group consisting of calcium carbonate, sand, mica, glass microspheres, non-pozzolanic perlite, coated perlite, talcs, and hydrated alumina.

Clause K11. The gypsum fiber panel of any of clauses A1 to J10, wherein the fiber-reinforced gypsum board core layer comprises 90 to 94 wt. % gypsum and 6-10 wt. % cellulose fibers.

Clause L12. The gypsum fiber panel of any of clauses A1 to K11, wherein the fiber-reinforced gypsum board core layer has a thickness of about 6.3 to 15.9 mm (0.25 to 0.625 inches).

Clause M13. The gypsum fiber panel of any of clauses A1 to K11, wherein the gypsum fiber panel meets the ANSI waterproofness standard for 24″ water column performance A118.10 American National Standard Specifications for Load Bearing, Bonded, Waterproof Membranes for Thin-set Ceramic Tile and Dimension Stone Installation 2014.

Clause N14. The gypsum fiber panel of any of clauses A1 to K11, wherein the gypsum fiber panel when tested per the ANSI waterproofness standard for 24″ water column performance A118.10 American National Standard Specifications for Load Bearing, Bonded, Waterproof Membranes for Thin-set Ceramic Tile and Dimension Stone Installation 2014, demonstrates no drop in water level in the water column tube after 48 hours the test is initiated.

Clause O15. The gypsum fiber panel of any of clauses A1 to N14, wherein the hydrophobic coating results from curing a layer of liquid hydrophobic finish composition applied in an amount of 30 to 200 lbs./msf, preferably 35 to 150 lbs./msf, more preferably 40 to 125 lbs/msf, most preferably 45 to 100 lbs/msf, wherein said liquid hydrophobic finish composition comprises water, typically about 5 to about 35%, preferably about 5 to about 30%, by weight water; and a remainder of the ingredients of the hydrophobic coating.

Clause P16. The gypsum fiber panel of any of clauses A1, H8 or 19, wherein the non-setting, inorganic filler comprises 50 wt. % or more calcium carbonate by weight of the non-setting, inorganic filler.

Clause Q17. A method of making the gypsum fiber panel of any of clauses A1 to P16, comprising:
providing an aqueous slurry comprising gypsum and a first portion of cellulose fibers to a reactor, reacting the gypsum and a first portion of cellulose fiber in a reactor to produce a calcined crystalline gypsum and cellulose fiber slurry,
adding to the first slurry a second portion of cellulose fiber slurry after the reactor step to form a second slurry,
depositing the second slurry to form a mat,
dewatering the mat,
rehydrating the mat to a gypsum cellulose fiber mat,
then drying the gypsum cellulose fiber mat,
cutting the gypsum cellulose fiber mat into a final gypsum fiber panel, and
applying the hydrophobic coating after drying to the gypsum cellulose fiber mat or applying the hydrophobic coating after cutting to the final gypsum fiber panel.

Clause R18. The method of clause Q17, wherein applying the hydrophobic coating comprises applying a layer of liquid hydrophobic finish composition in an amount of 30 to 200 lbs./msf, preferably 35 to 150 lbs./msf, more preferably 40 to 125 lbs/msf, most preferably 45 to 100 lbs/msf, wherein said liquid hydrophobic finish composition comprises water, typically about 5 to about 35%, preferably about 5 to about 30%, by weight water; and a remainder of the ingredients of the hydrophobic coating.

While particular embodiments of the present invention have been shown and described, it will be appreciated by those skilled in the art that changes and modifications may be made thereto without departing from the invention in its broader aspects and as set forth in the following claims.

1. A gypsum fiber panel (GFP) comprising:
a fiber-reinforced gypsum board core layer comprising:
gypsum,
cellulose fibers embedded uniformly throughout the core layer,
a siloxane level of 0 to about 1.0 wt. % uniformly distributed within the gypsum board core layer; and
a hydrophobic coating on the core layer, wherein the hydrophobic coating comprises as ingredients:
a film forming polymer, and
at least one of:
a non-setting inorganic filler, having a volume mean particle diameter of about 4 microns to about 100 microns, and
a hydraulic component comprising a fly ash,
wherein, if the hydraulic component is present, the hydrophobic coating further comprises at least one member of the group consisting of:
an extended flow time retention agent comprising at least one member selected from the group consisting of carboxylic acids, salts of carboxylic acids, and mixtures thereof, and
optionally a silane;
wherein the gypsum fiber panel has no facer mat or mesh on its surface;
wherein the gypsum fiber panel has no embedded mat or mesh.

2. The gypsum fiber panel of claim 1, wherein the fiber-reinforced gypsum board core layer comprises about 70 to about 93 wt. % gypsum and about 4 to about 20 wt. %, about 5 to about 15 wt. %, about 6 wt. % to about 12 wt. % cellulose fiber.

3. The gypsum fiber panel of claim 1, wherein the fiber-reinforced gypsum board core layer comprises 0.1 to 0.9 wt. % siloxane.

4. The gypsum fiber panel of claim 1, wherein the fiber-reinforced gypsum board core layer has a density of 56 to 90 lbs./ft².

5. The gypsum fiber panel of claim 1, wherein the hydrophobic coating results from curing a layer of hydrophobic finish composition comprising:
about 5 to about 30% by weight water;
about 5% to about 25% by weight said film-forming polymer
about 50% to about 85% by weight said hydraulic component, wherein at least half of the hydraulic component by weight is Class C fly ash; and
at least one member of the group consisting of:
5% by weight or less said silane, and
said extended flow time retention agent in an amount on a dry basis equal to 0.05-1.00 wt. % by weight of said hydraulic component.

6. The gypsum fiber panel of claim 1, wherein the hydrophobic coating results from curing a layer of hydrophobic finish composition comprising:
about 7.5 to about 25% by weight water;
about 7.5% to about 22.5% by weight said film-forming polymer
about 55% to about 75% by weight said hydraulic component, wherein at least half of the hydraulic component by weight is Class C fly ash; and
at least one member of the group consisting of:
0 to 3% by weight said silane, and
said extended flow time retention agent in an amount on a dry basis equal to 0.075-0.75 wt. % by weight of said hydraulic component.

7. The gypsum fiber panel of claim 1, wherein the hydrophobic coating results from curing a layer of hydrophobic finish composition comprising:
about 10 to about 20% by weight water;
about 10% to about 20% by weight said film-forming polymer;
about 60% to about 70% by weight said hydraulic component, wherein at least half of the hydraulic component by weight is Class C fly ash; and
at least one member of the group consisting of:
0.2 to 1% by weight said silane, and
said extended flow time retention agent in an amount on a dry basis equal to 0.10-0.50 wt. % by weight of said hydraulic component.

8. The gypsum fiber panel of claim 1, wherein the hydrophobic coating results from curing a layer of hydrophobic finish composition comprising:
(i) about 50 to about 80 weight % non-setting, inorganic filler having a volume mean particle diameter of about 4 microns to about 100 microns,
(ii) about 20% to about 50 weight % an aqueous dispersion of a film-forming polymer,
(iii) 0% to about 30 weight % additional water;
(iv) an absence of fly ash,
(v) an absence of pozzolanic material,
(vi) an absence of hydraulic cement,
(vii) an absence of calcium sulfate hemihydrate, and
(viii) an absence of calcium sulfate anhydrite.

9. The gypsum fiber panel of claim 1, wherein the hydrophobic coating results from curing a layer of hydrophobic finish composition comprising:
(i) about 50 to about 80 weight % non-setting, inorganic filler having a volume mean particle diameter of about 12 microns to about 35 microns,
(ii) about 20% to about 50 weight % an aqueous dispersion of a film-forming polymer,
(iii) 0% to about 30 weight % additional water.

10. The gypsum fiber panel of claim 1, wherein the non-setting, inorganic filler comprises at least one member selected from the group consisting of calcium carbonate, sand, mica, glass microspheres, non-pozzolanic perlite, coated perlite, talcs, and hydrated alumina.

11. The gypsum fiber panel of claim 1, wherein the fiber-reinforced gypsum board core layer comprises 90 to 94 wt. % gypsum and 6-10 wt. % cellulose fibers.

12. The gypsum fiber panel of claim 1, wherein the fiber-reinforced gypsum board core layer has a thickness of about 6.3 to 15.9 mm (0.25 to 0.625 inches).

13. The gypsum fiber panel of claim 1, wherein the gypsum fiber panel meets the ANSI waterproofness standard for 24″ water column performance A118.10 American National Standard Specifications for Load Bearing, Bonded, Waterproof Membranes for Thin-set Ceramic Tile and Dimension Stone Installation 2014.

14. The gypsum fiber panel of claim 1, wherein the gypsum fiber panel when tested per the ANSI waterproofness standard for 24″ water column performance A118.10 American National Standard Specifications for Load Bearing, Bonded, Waterproof Membranes for Thin-set Ceramic Tile and Dimension Stone Installation 2014, demonstrates no drop in water level in the water column tube after 48 hours the test is initiated.

15. The gypsum fiber panel of claim 1, wherein the hydrophobic coating results from curing a layer of liquid hydrophobic finish composition applied in an amount of 30 to 200 lbs./msf, wherein said liquid hydrophobic finish composition comprises water and a remainder of the ingredients of the hydrophobic coating.

16. The gypsum fiber panel of claim 1, wherein the non-setting, inorganic filler comprises 50 wt. % or more calcium carbonate by weight of the non-setting, inorganic filler.

17. A method of making the gypsum fiber panel of claim 1, comprising:
providing an aqueous slurry comprising gypsum and a first portion of cellulose fibers to a reactor, reacting the gypsum and a first portion of cellulose fiber in a reactor to produce a calcined crystalline gypsum and cellulose fiber slurry,
adding to the first slurry a second portion of cellulose fiber slurry after the reactor step to form a second slurry,
depositing the second slurry to form a mat,
dewatering the mat,
rehydrating the mat to a gypsum cellulose fiber mat,
then drying the gypsum cellulose fiber mat,
cutting the gypsum cellulose fiber mat into a final gypsum fiber panel, and
applying the hydrophobic coating after drying to the gypsum cellulose fiber mat or applying the hydrophobic coating after cutting to the final gypsum fiber panel.

18. The method of claim 17, wherein applying the hydrophobic coating comprises applying a layer of liquid hydrophobic finish composition in an amount of 30 to 200 lbs./msf, wherein said liquid hydrophobic finish composition comprises water and a remainder of the ingredients of the hydrophobic coating.
